(19) United States
(12) Patent Application Publication
(10) Pub. No.: US 2014/0295134 A1
(43) Pub. Date: Oct. 2, 2014

(54) ABSORBENT FOAM COMPOSITES

(71) Applicant: 3M INNOVATIVE PROPERTIES COMPANY, St. Paul, MN (US)

(72) Inventors: Leigh E. Wood, Woodbury, MN (US); Thomas J. Gilbert, Saint Paul, MN (US); Delton R. Thompson, JR., Lake Elmo, MN (US); Mark A. Peltier, Forest Lake, MN (US); Lori-Ann S. Prioleau, Saint Paul, MN (US)

(73) Assignee: 3M Innovative Properties Company, St. Paul, MN (US)

(21) Appl. No.: 13/854,411

(22) Filed: Apr. 1, 2013

(51) Int. Cl. B01J 20/28; B32B 38/04; B32B 3/26

(52) U.S. Cl. CPC B01J 20/28054; B01J 20/28095; B32B 3/266; B32B 38/04
USPC 428/135; 428/138; 428/137; 428/134; 156/252; 156/253

(57) ABSTRACT

An absorbent foam composite comprising a foam layer having open slits that define apertures on at least a portion of the foam layer and an absorbent layer. A heat set film may be sandwiched between the foam layer and the absorbent layer and have opened slits that define apertures that are at least partially congruent with the apertures of the foam layer. The absorbent layer may contain apertures or be aperture free. The absorbent foam composites can be used in a variety of applications, including personal hygiene articles, medical bandages, pet pads and agricultural pads.

### FIELD OF INVENTION

The present invention relates to absorbent foam composites and methods of making the absorbent foam composites. The absorbent foam composites can be used in a variety of disposable absorbent articles, including personal hygiene articles, medical bandages, pet pads and agricultural pads.

### BACKGROUND

Disposable absorbent articles typically include an absorbent core sandwiched between a fluid impervious backsheet and a fluid pervious topsheet. The absorbent core can be a single material or a composite of two or more materials. Exemplary composite cores are described in U.S. Ser. No. 61/652,388 and U.S. Ser. No. 61/652,408, which were co-filed on May 29, 2012. The exemplary composites include a polymeric foam layer and a second absorbent layer. The layers are sufficiently proximate each other such that fluid from the absorbent foam layer is readily transported to the second absorbent layer.

### SUMMARY

The present invention provides absorbent foam composites comprising an apertured foam layer and absorbent layer. The addition of apertures can enhance flexibility, conformability, drapability, fluid transport, and/or cost-in-use of absorbent foam composites. The invention also provides methods of making the absorbent foam composites.

In one embodiment, the invention provides an absorbent foam composite comprising a foam layer having open slits that define apertures on at least a portion of the foam layer, and an absorbent layer.

In another embodiment, the invention provides an absorbent foam composite comprising a foam layer having open slits that define apertures on at least a portion of the foam layer, an absorbent layer, and a heat set film sandwiched between the foam layer and the absorbent layer, the heat set film joined to the foam layer and having open slits that define apertures that are at least partially congruent with the apertures of the foam layer.

In a further embodiment, the invention provides a method of making an absorbent foam composite comprising slitting and spreading a foam layer to create open slits that define apertures, and combining an absorbent layer with the foam layer.

In yet a further embodiment, the invention provides a method of making an absorbent foam composite comprising slitting and spreading a foam layer to create open slits that define apertures, combining an absorbent layer with the foam layer, joining a heat-settable film to the foam layer such that the heat-settable film is sandwiched between the foam layer and the absorbent layer, slitting and spreading the heat-settable film simultaneously with the slitting and spreading of the foam layer to create open slits that define apertures in the heat-settable film that are at least partially congruent with the apertures in the foam layer, and annealing the heat-settable film to fix the slits in the foam layer and heat-settable layer in an open configuration.

As used herein, the terms “including,” “comprising,” or “having” and variations thereof encompass the items listed thereafter and equivalents thereof, as well as additional items. All numerical ranges are inclusive of their endpoints and non-integral values between the endpoints unless otherwise stated. Terms such “top,” “bottom,” and the like are only used to describe elements as they relate to one another, but are in no way meant to recite specific orientations of an article or apparatus, to indicate or imply necessary or required orientations of an article or apparatus, or to specify how an article or apparatus described herein will be used, mounted, displayed, or positioned in use.

The term “slit”, as used herein, refers to a cut that extends through one or more materials and is aligned predominately in one direction. The slit may be linear or the slit may be substantially linear, which means that the slit can have a slight curvature or slight oscillation.

The term “open slits”, as used herein, refers to slits that have been spread open to define apertures that extend through one or more materials. In instances where a material remains substantially planar during spreading, the apertures will extend from one side of the material to the opposite side of the material in a direction substantially perpendicular to the plane. In other instances where the material may rotate out of the plane during spreading (i.e., the material is no longer planar), the apertures may extend through the material at an angle to the original plane of the unspread material. Either way, the shape of a particular aperture and the size of a particular aperture remain essentially constant as the aperture extends through the material. For example, an open slit of the present disclosure does not define an aperture that becomes narrower or broader as it extends through a material.

The term “aperture”, as used herein, refers to an opening of sufficient size to permit passage of fluid. A perforation or small opening that allows passage of air and/or moisture vapor but not passage of fluid is not an aperture for the purpose of this disclosure.

The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure.

### BRIEF DESCRIPTION OF THE DRAWINGS

FIG. 1A is a cross-sectional view of an exemplary absorbent foam composite;

FIG. 1B is a perspective view of one embodiment of the exemplary foam composite in FIG. 1A, where a portion of the absorbent layer has been cut away to more clearly show the features;

FIG. 1C is a perspective view of an alternative embodiment of the exemplary foam composite in FIG. 1A, where the layers of the composite have been separated to more clearly show the features;

FIG. 2 is a cross-sectional view of another exemplary absorbent foam composite;

FIG. 3A is a top view of a foam layer having an exemplary pattern of slits;

FIG. 3B is a top view of the foam layer in FIG. 3A that has been spread to open the slits and create apertures;

FIG. 3C is a top view of the foam layer in FIG. 3A that has been spread further than in FIG. 3B to create larger apertures;

FIG. 4A is a top view of a foam layer having another exemplary pattern of slits;

FIG. 4B is a top view of the foam layer in FIG. 4A that has been spread to open the slits and create apertures;

FIG. 5A is a top view of a foam layer having still another exemplary pattern of slits;

FIG. 5B is a top view of the foam layer in FIG. 5A that has been spread to open the slits and create apertures, where the foam layer has been colored black to more clearly show the apertures;

FIG. 6A is a top view of a foam layer having yet another exemplary pattern of slits;

FIG. 6B is a top view of the foam layer in FIG. 6A that has been spread to open the slits and create apertures;

FIG. 6C is a top view of the foam layer in FIG. 5A that has been spread further than in FIG. 6B to create rectangular apertures.

FIG. 7 is a cross-section view of an article containing an absorbent foam composite.

### DETAILED DESCRIPTION

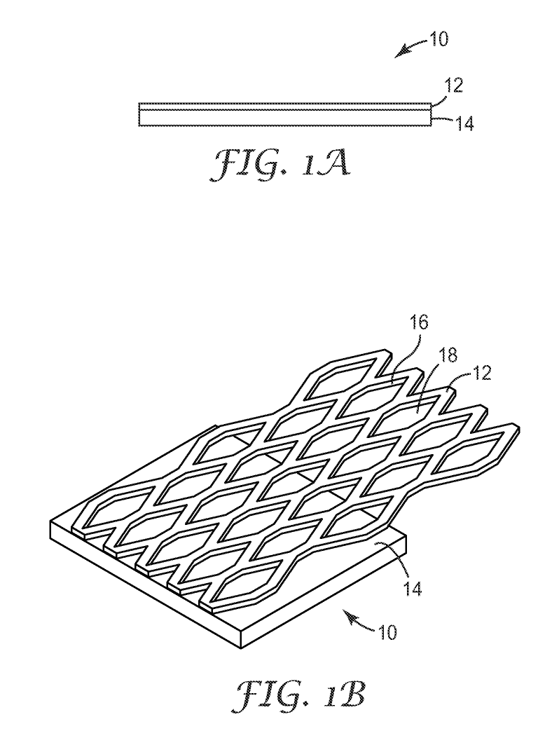

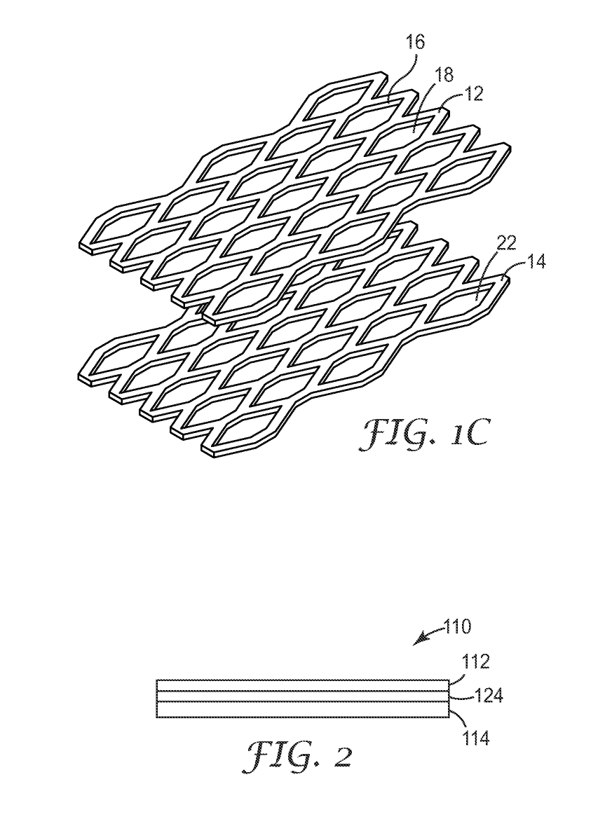

FIGS. 1A-1C illustrate an exemplary absorbent foam composite 10 of the present invention comprising a foam layer 12 and absorbent layer 14. The foam layer 12 has open slits 16 that define apertures 18 on at least a portion of the foam layer 12. The absorbent layer 14 may be joined to the foam layer 12, but can be in contact with the foam layer 12 without actually being joined. The absorbent layer 14 can be aperture free, as illustrated in FIG. 1B. Alternatively, the absorbent layer 14 can have apertures 22, as illustrated in FIG. 1C. In some embodiments, the apertures 22 in the absorbent layer 14 are at least partially congruent with the apertures 18 in the foam layer 12. In other embodiments, the apertures 22 in the absorbent layer 14 are congruent with the apertures 18 in the foam layer 12.

The slits in the foam layer can be fixed in the open position using any of several techniques. In one embodiment, the foam layer is slit, spread in a direction substantially perpendicular to the slits to create apertures, and attached to a component with sufficient rigidity to prevent the foam layer from retracting and closing the slits. The component could be the absorbent layer of the absorbent foam composite. Alternatively, the component may be part (e.g., a topsheet or a backsheet) of an article into which the absorbent foam composite is incorporated. For example, the edges of the spread slit foam layer could be attached to the backsheet of a disposable absorbent article, creating a pocket between the foam layer and backsheet that is occupied by the absorbent layer.

In another embodiment, the spread foam layer is annealed to prevent the foam layer from completely retracting and closing the slits. Some retraction of the foam layer may occur after the annealing process. In some cases, retraction can occur as much as 50% or more. For this reason, the foam layer is typically spread more than desired during the annealing process to account for any possible retraction afterwards.

In yet another embodiment, the foam layer can be joined to a heat-settable film, the foam layer and film simultaneously slit and spread in a direction substantially perpendicular to the direction of the slits to create apertures, and the film annealed to prevent the foam layer from retracting and closing the slits. This technique can be more precise than annealing just the foam layer, as noted above. FIG. 2 illustrates an absorbent foam composite 110 made according to this technique. A heat set film 124 (i.e., an annealed heat-settable film) is sandwiched between the foam layer 112 and the absorbent layer 114. The heat set film 124 is joined to the foam layer 112 and has open slits (not shown) that define apertures that are at least partially congruent with the apertures of the foam layer. As with the absorbent foam composite of FIGS. 1A-1C, the absorbent layer 114 may or may not comprise apertures. The absorbent layer 114 may be joined to the heat set film 124, but can be in contact with the heat set film 124 without actually being joined.

The absorbent foam composites of the present invention acquire, distribute, and/or store aqueous fluids, such as water, urine, menses, blood or the like, in disposable absorbent articles. In favored embodiments, the fluid is transported primarily through the apertures in the foam layer and stored in the absorbent layer. Although some fluid could be retained in the foam layer, depending upon the composition of the foam, it is preferable that more of the fluid be stored in the absorbent layer to minimize rewet.

The absorbent foam composites of the present invention can offer a number of advantages. For example, by changing the nature of the foam layer, it is possible to tailor the strikethrough and rewet properties of the absorbent foam composite to a particular application. This is possible because the primary fluid transport mechanism is through the apertures of the foam layer and not through the interior of the foam layer. When rewet is of primary concern, hydrophobic foams that absorb little-to-no fluid may be used in combination with the absorbent layer. The hydrophobic layer repels the fluid which is transported through the apertures to the absorbent layer. In the case of a personal hygiene article, for example, the relatively dry, hydrophobic foam layer separates the user from the absorbent layer, thus minimizing rewet.

On the other hand, an open cell hydrophilic foam layer can be used when strike through is of greater importance. Although fluid will still pass through the apertures in the film, fluid can also be transported through the open cell network in the hydrophilic foam. This combination of transport mechanisms can enhance the strike through properties of the absorbent foam composite. However, the hydrophilic nature of the foam means that at least some fluid will remain in the foam layer, potentially effecting rewet performance.

Rewet performance and strike through performance are typically inversely related. A composite with improved rewet performance will typically exhibit decreased strike through performance, and vise versa. Since the apertures in the foam layer function as the primary fluid transport mechanism in the absorbent foam composite, it is possible to choose from a variety of foams (e.g., hydrophobic, hydrophilic, open cell, and closed cell) in order to produce an absorbent foam composite having the desired performance for a given application.

The apertured foam layer can also provide better conformability, flexibility and drapability than a non-apertured foam layer. This may be particularly relevant when the absorbent foam composite is used in diapers, feminine hygiene articles, and adult incontinence pads where the articles need to conform to the user and are often subject to twisting and bending motions.

Additionally, the apertured foam layer can reduce cost through material reduction. By using apertures as the primary fluid transport mechanism, it is possible to use less foam material than would be required when the open cells of a hydrophilic foam, for example, are the primary fluid transport mechanism. In addition, slitting and spreading the foam layer to create the apertures generates no material waste, as would occur if apertures were created by a punching process.

Slitting and spreading the foam to create apertures also provides greater design flexibility than would be available if the apertured foam layer was created with standard molding techniques. In the present invention, the shape, size and location of apertures within a foam layer can be varied by simply changing the slit pattern, whereas the entire mold would need to be change in a molding process.

### Slit Patterns

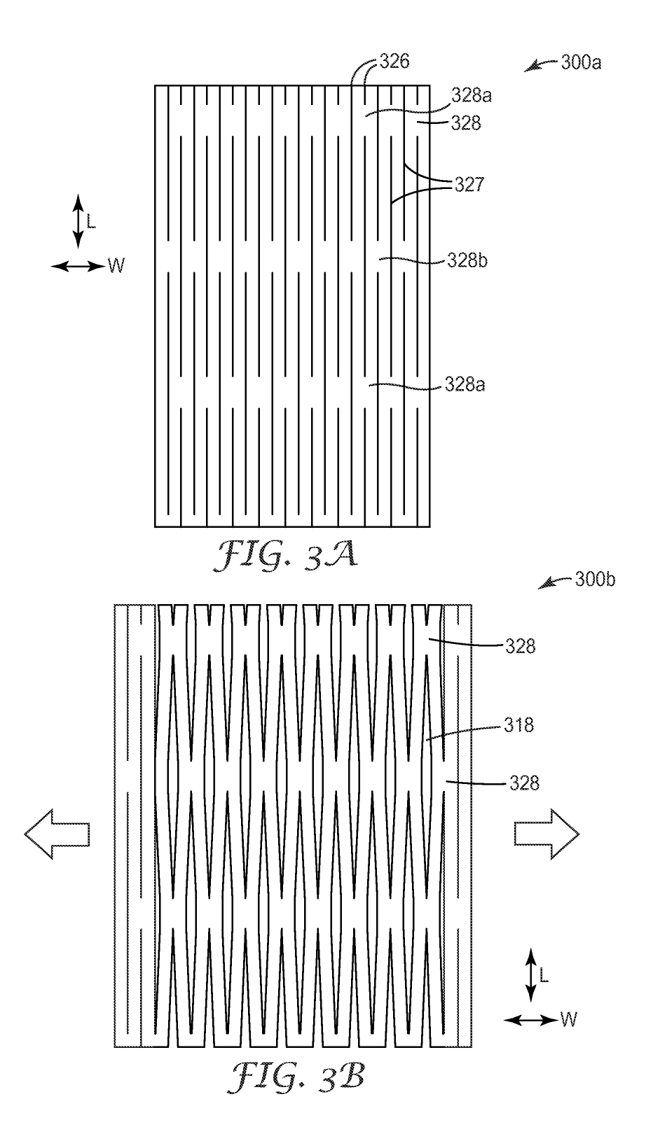

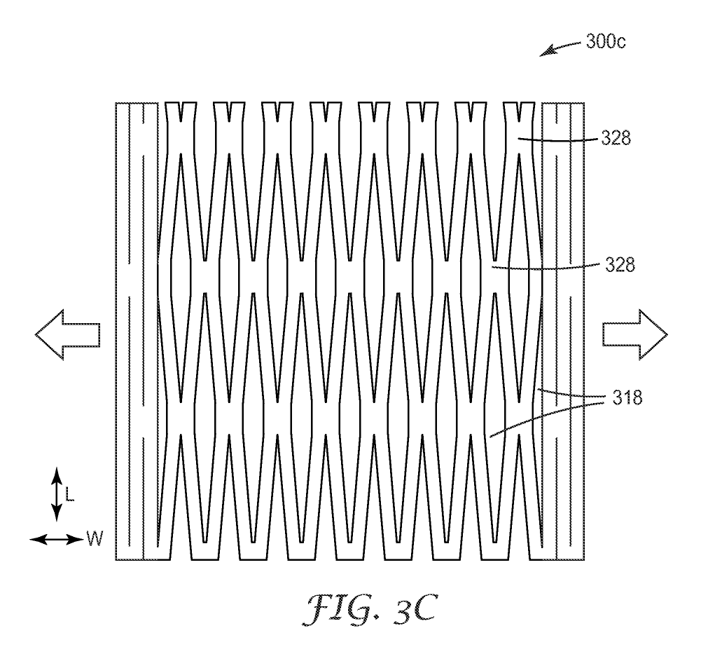

A variety of slit patterns can be used to create apertures of varying size, shape and location. FIG. 3A illustrates one exemplary pattern of slits that can be used to create apertures in the foam layer of the absorbent foam composite. The slit foam layer 300a exhibits rows 326 of slits 327 extending in direction “L” and interrupted by bridging regions 328. The bridging regions 328 are regions where the foam layer is not cut through. The bridging regions 328 are staggered in a direction “W” perpendicular to the direction “L”. The bridging regions 328a and 328b are staggered such that bridging region 328b is located substantially midway between bridging regions 328a in the direction “L”.

FIGS. 3B and 3C illustrate the effect of spreading the slit foam layer 300a in FIG. 3A to different extents and also illustrate an apertured foam layer 300b, 300c according to the present invention. When the slit foam layer is spread in the direction of the arrows shown, the slits open to create apertures 318. Spreading can be carried out to increase the width of the slit foam layer (that is, the dimension of the direction of the spreading) to any extent desired. Increasing the width of the slit foam layer at least 5 percent may be sufficient to create apertures. In some embodiments, the width of the slit foam layer is increased at least 10, 15, 25, 30, 40, or 50 percent. In some embodiments, the width of the slit foam layer is increased up to 70, 100, 200, 250, or 300 percent. It should be understood that the upper end of the width increase will depend to some extent upon the nature of the foam, as well as the size and patterns of slits used to create apertures. In some embodiments, the upper end of the width increase will also depend upon the nature of the heat set film and/or the absorbent layer.

Spreading may be carried out to open all slits, or spreading may be carried out so that some but not all slits are opened. In FIGS. 3B and 3C, the slits on the edges of the slit foam layer remain closed. This configuration would be desired for applications that require a foam layer with a straight edge. A similar effect could be obtained by omitting slits near the side edges of the absorbent foam, thus leaving straight edges. In some embodiments, the slits are opened the same amount across the foam layer. In other embodiments, the slits may be opened to different degrees across the foam layer. For example, the slits may be spread further apart in the center of the foam layer but spread to a lesser degree as the slits approach the edges of the foam layer.

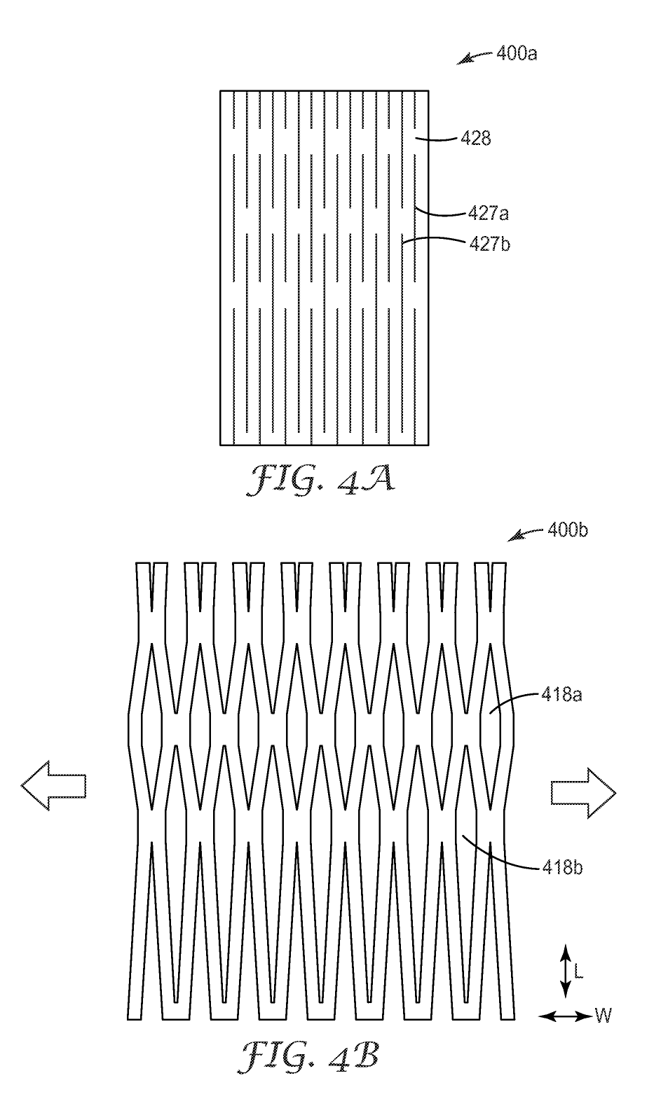

FIG. 4A illustrates another exemplary pattern of slits similar to the pattern of FIG. 3A. However, in the embodiment shown in FIG. 4A, slits 427a have different lengths than slits 427b, which results in apertures 418a and 418b having different sizes after the slit foam layer 400a is spread, as shown in FIG. 4B. The smaller slits 427a and larger slits 427b may be aligned with each other across the foam layer as shown in FIG. 4A. Or, in other embodiments, slits of different sizes may be arranged randomly in the foam layer or slits of the same size may be offset relative to each other in a regular pattern.

In the apertured foam layer 400b shown in FIG. 4B, apertures 418a and 418b have different sizes. That is, apertures 418a are shorter in the longitudinal direction “L” than apertures 418b. It is also possible to make apertures that have different widths in a direction “W” perpendicular to the slits by using slits of varying lengths. Furthermore, referring again to FIG. 4A, the length of the bridging regions 428 may be made to vary as desired for a particular application or appearance.

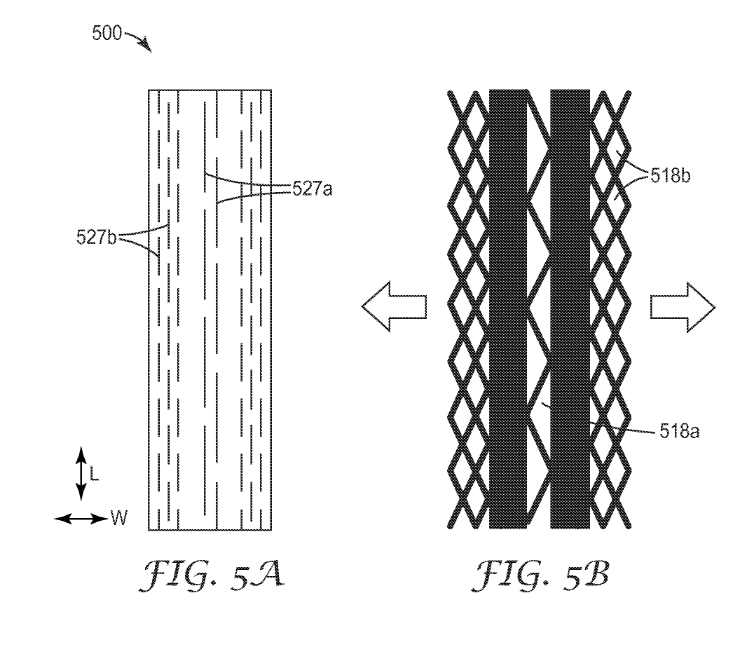

FIG. 5A illustrates yet another exemplary pattern of slits similar to the pattern FIG. 3A. However, in the embodiment shown in FIG. 5A, the slits 527a in the center of the slit foam layer 500 are larger than the slits 527b near the edges of the slit foam layer. This configuration of slits allows for larger apertures 518a in the center of the foam layer and smaller apertures 518b near the edges of the foam layer. This embodiment may be particularly useful in diapers, feminine hygiene pads or adult incontinence pads where fluid discharge may be greatest in the center of the absorbent foam layer.

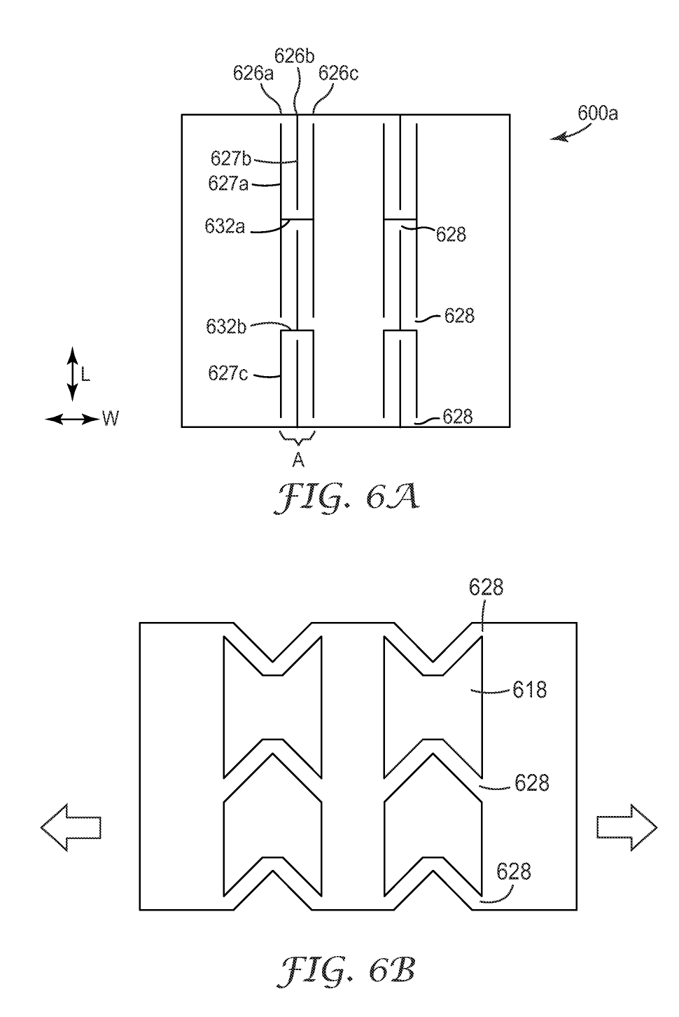

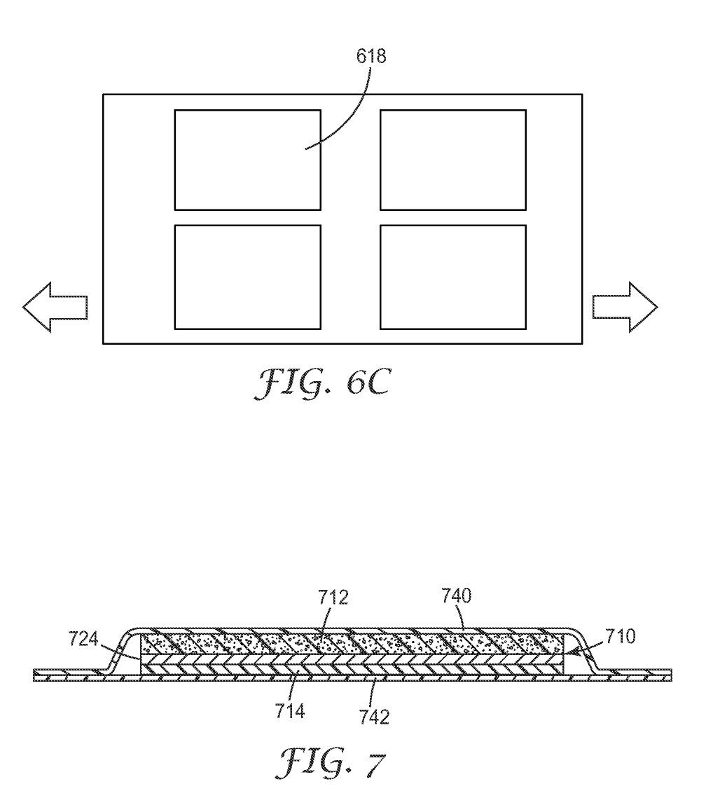

FIGS. 6A-C illustrates still another exemplary pattern of slits in the foam layer of the absorbent foam composite that creates rectangular apertures 618. The rectangular apertures are created from a group “A” of three rows 626a, 626b and 626c of slits extending in direction “L”. The center row 626b comprises center slits 627b. The two rows 626a, 626c on either side of the center row 626b comprise a long slit 627a and a short slit 627c. Slit 627b is shorter than slit 627a but relatively the same size as slit 627c. At least some of bridging regions 628 are provided with a transverse slit extending in direction “W” between the two outer rows 626a, 626c of slits. In the illustrated embodiment, a transverse slit 632a connects slits 627a in rows 626a and 626c. Similarly, a transverse slit 632b connects slits 627c in rows 626a and 626c. FIGS. 6B and 6C illustrate the formation of apertures 618 when the slit foam layer 600a is spread in the direction shown. The apertured foam layer in FIG. 6C has rectangular apertures. Although two groups “A” are represented in FIGS. 6A-C, it should be understood that the slit form layer can have only one group or more than two groups.

Although the methods of making apertured foam layers illustrated in FIGS. 3A-3C, 4A-4B, 5A-5B, and 6A-6C each show slits extending parallel to the longitudinal direction of the slit foam layer, slits may be made in any desired direction. For example, slits may be made at an angle from 1 to 90 degrees to the longitudinal direction of the foam layer. When the methods disclosed herein are practiced on a continuous foam web, slits may be made in the machine direction, the cross-direction, or any desired angle in between the machine direction and the cross-direction. In some embodiments, slits in the foam layer may be made at an angle in a range from 35 to 55 degrees (e.g., 45 degrees) to the longitudinal direction of the foam layer.

For the embodiments of apertured foam layers or methods of making them illustrated in FIGS. 3A-3C, 4A-4B, and 5A-5B, the bridging regions are staggered in a direction “W” perpendicular to the direction “L” of the slits. For example, referring again to FIG. 3A, the bridging regions 328a and 328b are substantially evenly spaced apart within their respective rows in the direction “L” but are staggered in the direction “W”, perpendicular to the direction “L”. In other embodiments, it is contemplated that the bridging regions can be aligned in a direction “W” perpendicular to the direction of the slits.

The number and size of apertures in the foam layer can be controlled, for example, by the length of the slits. The particular arrangement of the bridging regions, whether aligned or staggered in a direction perpendicular to the slits, can be designed, for example, based on the desired length of the slits and the desired amount of spreading to open the slits. Various lengths of bridging regions may be useful. In some embodiments, any bridging regions in a given row of slits may have a combined length of up to 50 (in some embodiments, 40, 30, 25, 20, 15, or 10) percent of the row length. In some embodiments, for maximizing the ability of the slit foam layer to spread, it may be desirable to minimize the combined length of the bridging regions within a row. Minimizing the combined length of the bridging regions may be accomplished by at least one of minimizing the length of any particular bridging region or maximizing the length of the slits. In some embodiments, the length of one bridging region in a row of slits is up to 3, 2, or 1.5 mm and at least 0.25, 0.5, or 0.75 mm. In some embodiments, the number of bridging regions within a row of slits is up to 1.5, 1.25, 1.0, 0.75, 0.60, or 0.5 per cm. Furthermore, the length of slits between bridging regions can be adjusted and may be selected to maximize the distance between bridging regions. In some embodiments, the length of the slits between bridging regions is at least 2 (in some embodiments, at least 3, 5, 9, 10, 12, 14, 15, 16, 17, 18, 19, or 20) mm. The distance between rows of slits may be, for example, at least 0.5 mm, 0.7 mm, 1.0 mm or 1.5 mm. It should be understood that a variety of permutations of slit length, bridge lengths, distances between slit rows are possible. In some embodiments, the slit pattern has rows of 5 mm slits separated by 2 mm bridging regions. Adjacent rows of slits are separated by 2 mm and the slits within adjacent rows are offset by 2.5 mm. In other embodiments, the slit pattern has rows of 13 mm slits separated by 2 mm bridging regions. Adjacent rows of slits are separated by 3 mm and the slits within adjacent rows are offset by 6.5 mm.

The apertured foam layers illustrated in FIGS. 3B-3C, 4B, 5B and 6B-6C are meant to be representative examples. It should be understood that the shape, size, number, pattern, and location of apertures can be easily varied by changing, for example, the number of rows of slits, length of slits, the distance between rows of slits, the shape of slits, the location of slits in the foam layer, and degree of spreading to open the slits. Apertures can extend across the entire foam layer or appear in one or more isolated areas of the foam layer.

The apertures in the foam layer of the present invention can be a variety of shapes. In the illustrated embodiments in FIGS. 3B-3C, 4B, 5B and 6B-6C, the apertures are rectangular or diamond-shaped. In other embodiments, the apertures can have the shape of polygons (e.g., squares) and ovals. In other embodiments, curved slits can create apertures having a crescent shape or s-shape. As shown in FIGS. 5A-5B, there can be more than one repeating pattern of geometric shaped apertures. The apertures can be evenly spaced or unevenly spaced, as desired.

Although the above slit patterns have been described with respect to the foam layer, it should be understood that the same pattern can be imparted to the heat-settable film layer and/or absorbent layer. Absorbent foam composites, in which a heat-settable film layer is used to fix the foam layer slits in an open configuration, will typically exhibit the same slit pattern in both the foam layer and heat-settable film. This is accomplished by joining the heat-settable film to the foam layer, simultaneously slitting through both the foam layer and heat-settable film, spreading the foam layer and heat-settable film to open the slits and create apertures, and annealing the heat-settable film to fix the slits in an open configuration. Preferably, the apertures of the heat-set film are congruent with the apertures of the foam layer in the absorbent foam composite. However, the apertures of the heat set film need only be partially congruent with the foam layer in order to allow fluid to pass through the foam layer to the absorbent layer when the absorbent foam composite is in use. For example, in some instances when a heat-settable film was adhesively attached to the foam layer, the heat-settable film apertures would slightly off-set from the apertures of the foam layer during spreading.

It is also possible to position the absorbent layer below the foam layer, or optional heat-settable film, and slit the absorbent layer simultaneously with the foam layer. However, it is not necessary that the absorbent layer have apertures. Moreover, it is not necessary that such apertures completely align with those in the foam layer. Therefore, apertures could be created in the absorbent layer using a different process and/or pattern prior to combining with the foam layer (or optional heat-settable film).

### Method of Making Absorbent Foam Composites

The absorbent foam composites of the present invention are made by slitting and spreading a foam layer to create open slits that define apertures, and combining an absorbent layer with the foam layer. The combining step can occur before or after the slitting. The term “combining” as used herein, means that the foam layer and absorbent layer are in close proximity such that fluid flows through the apertures of the foam layer to the absorbent layer below. In some embodiments, the absorbent layer is joined to the foam layer. In other embodiments, the absorbent layer is in contact with, but not joined, to the foam layer. In yet other embodiments, the absorbent layer and foam layer are separated by, for example, a heat-settable film. The absorbent layer may be joined to the heat-settable film or, alternatively, in contact with, but not joined, to the heat-settable film. The absorbent foam composites can be made in a continuous process or in a batch-type process.

In some embodiments, the absorbent layer is joined to the foam layer (or heat-settable film) by, for example, adhesive lamination. Examples of suitable adhesives include emulsion, hot melt, curable, or solvent-based adhesives. Suitable pressure sensitive adhesives include (meth)acrylate-based pressure sensitive adhesives, polyurethane adhesives, natural or synthetic rubber-based adhesives, epoxy adhesives, curable adhesives, phenolic adhesives, and the like. In embodiments comprising a heat-settable film, the heat-settable film can be applied to the absorbent layer (e.g., by polycoating techniques) and subsequently joined to the foam layer.

In some embodiments, the absorbent layer is aperture free. In other embodiments, the absorbent layer comprises apertures. In yet other embodiments, the absorbent layer is joined to the foam layer, and the absorbent layer is slit and spread simultaneously with slitting and spreading of the foam layer to create opened slits that define apertures in the absorbent layer that are congruent with the apertures in the foam layer.

The foam layer may be annealed after slitting and spreading the foam layer to fix the slits in an open configuration. Alternatively, a heat-settable film can be joined to the foam layer (e.g., by adhesive laminate or by directly casting the foam onto the film) such that the heat-settable film is sandwiched between the foam layer and absorbent layer. The heat-settable film is slit and spread simultaneously with slitting and spreading the foam layer to create open slits that define apertures in the heat-settable film that are at least partially congruent with the apertures in the foam layer. The heat-settable film is then annealed to fix the slits in the foam layer and heat-settable layer in an open configuration.

The foam layer may be slit using any number of methods. For example, in a continuous process, a skip slitting apparatus comprising a rotary die can be used to slit a continuous web of foam. The rotary die could have rotary cutting blades with gaps to allow for bridging regions between slits within a row. Other slitting methods (e.g., laser cutting) may also be used. Slits can be oriented substantially in the machine direction (MD), cross-direction (CD) or any angle in between.

Spreading can be carried out on a continuous web using, for example, a flat film tenter apparatus, diverging rails, diverging disks, or a series of bowed rollers. When spreading is desired in the machine direction of a continuous web (e.g., when slits extend substantially in the cross-direction), monoaxial spreading in the machine direction can be performed by propelling the web over rolls of increasing speed, with the downweb roll speed faster than the upweb roll speed. Other methods for spreading (and annealing) a slit web are described, for example, in U.S. Ser. No. 61/647,833 and U.S. Ser. No. 61/647,862, each filed on May 16, 2012; and International PCT Application No. CN2012/075734, filed on May 18, 2012.

The slits in the foam layer can be fixed in the open position using any of several techniques. In one embodiment, the foam layer is slit, spread in a direction substantially perpendicular to the slits to create apertures, and attached to a component with sufficient rigidity to prevent the foam layer from retracting and closing the slits. In another embodiment, the spread foam layer is annealed to prevent the foam layer from completely retracting and closing the slits. In yet another embodiment, the foam layer can be joined to a heat-settable film, the foam layer and film simultaneously slit and spread in a direction substantially perpendicular to the direction of the slits to create apertures, and the film annealed to prevent the foam layer from retracting and closing the slits. In some embodiments, annealing comprises heating the foam layer and/or heat-settable film. In some embodiments, annealing comprises heating and then cooling (e.g., rapidly cooling) the foam layer and/or heat-settable film. Heating may be carried out on a continuous web, for example, using heated rollers, IR irradiation, hot air treatment or by performing the spreading in a heat chamber or oven.

In one embodiment of making an absorbent foam composite, a web of foam is slit and spread to create opened slits. The foam is annealed to fix the slits in an open configuration and combined with a web of absorbent material to create an absorbent foam composite. The composite can be cut to desired size and/or shape, as required for the intended application.

In another embodiment of making an absorbent foam composite, a web of foam can be joined to a web of absorbent material (and optionally a web of heat-settable film). The foam and absorbent material (and optionally web of heat-settable film) are simultaneously slit and spread to create open slits defining apertures. The absorbent foam composite can be cut to desired size and/or shape, as required for the intended application and joined to an article in the spread configuration. In particular embodiments having a heat-settable film, the foam layer can be annealed to fix the slits in an open configuration.

In another embodiment of making an absorbent foam composite, the foam is continuously cast onto a web of heat-settable film. The foam and heat-settable film are then simultaneously slit and spread to create open slits that define apertures. The composite web (foam and heat-settable film) is heated to anneal the heat-settable film and, optionally, the foam layer to maintain the slits in an open configuration. The composite web is then combined with a web of absorbent material to create an absorbent foam composite. The composite can be cut to desired size and/or shape, as required for the intended application.

### Foam Layer

Suitable foams are relatively compression resistant, conformable, flexible and resilient. Typically the foams will have an indentation force deflection ranging from about 30N to about 75N at 50% and a constant deflection compression set ranging from about 0.5% to about 30% as determined according to ASTM D3574-11. In the case of polyurethane foams, the index is typically less than 100. The foams can by hydrophobic or hydrophilic and have open or closed cells. Exemplary foams include polyurethanes, polyolefins (e.g., polypropylenes and polyethylenes), co-polymers of polyolefins, polyacrylics, polyamides, polyvinyl chlorides, epoxys, polystyrenes, and melamine-formaldehyde polymer. By way of example, suitable open cell hydrophilic polyurethanes will be described in further detail below.

Polyurethane foams can be made by mixing together polyisocyanates, polyols, water (and/or a chemical blowing agent) and optional additives, allowing the mixture to foam, and curing the foamed mixture. In practice, it is common to provide the polyisocyanate(s) in one liquid stream and a blend of the polyol(s), water (and/or chemical blowing agent) and optional additives in a second liquid stream. The streams are often referred to as “iso” and “poly”, respectively, and when combined produce the polyurethane foam. More than two liquid streams may be contemplated. However, the polyisocyanates and blend of polyols and water (and/or chemical blowing agent) are kept in separate liquid streams.

The polyisocyanate component may comprise one or more polyisocyanates. Various aliphatic and aromatic polyisocyanates have been described in the art. The polyisocyanates utilized in forming the polyurethane foam typically have a functionality between 2 and 3.

In one embodiment, the foam is prepared from at least one aromatic polyisocyanate. Examples of aromatic polyisocyanates include toluene 2,4- and 2,6-diisocyanate (TDI), naphthalene 1,5-diisocyanate, and 4,4′-, 2,4′- and 2,2′-methylene diphenyl diisocyanate (MDI).

In favored embodiments, the foam is prepared from one or more (e.g. aromatic) polymeric polyisocyanates. Polymeric polyisocyanates typically have a (weight average) molecular weight greater than a monomeric polyisocyanate (lacking repeating units), yet lower than a polyurethane prepolymer. The linking groups in polymeric polyisocyanates may include isocyanurate groups, biuret groups, carbodiimide groups, uretonimine groups, uretdione groups, etc. as known in the art.

Some polymeric polyisocyanates may be referred to as “modified monomeric isocyanate”. For example, pure 4,4′-MDI is a solid having a melting point of 38° C. and an equivalent weight of 125 g/equivalent. However, modified MDIs are liquid at 38° C. and have a higher equivalent weight (e.g. 143 g/equivalent). The difference in melting point and equivalent weight is believed to be a result of a small degree of polymerization, such as by the inclusion of linking groups, as described above.

Polymeric polyisocyanates, including modified monomeric polyisocyanates, may comprise a mixture of monomer in combination with polymeric species inclusive of oligomeric species. For example, polymeric MDI is reported to contain 25-80% monomeric 4,4′-methylene diphenyl diisocyanate as well as oligomers containing 3-6 rings and other minor isomers, such as 2,2′ isomer.

In some embodiments, the polymeric polyisocyanates have a viscosity from about 10 to 300 cps at 25° C., an equivalent weight from about 130 to 250 g/equivalent, and an average molecular weight (Mw) of no greater than about 500 Da.

In some embodiments, the polyurethane is derived from a single polymeric polyisocyanate or a blend of polymeric isocyanates. Thus, 100% of the polyisocyanate component is polymeric polyisocyanate(s). In other embodiments, a major portion of the polyisocyanate component is a single polymeric polyisocyanate or a blend of polymeric isocyanates. In these embodiments, at least 50, 60, 70, 75, 80, 85 or 90 wt-% of the polyisocyanate component is polymeric isocyanate(s).

Commercially available polyisocyanates include SUPRASEC® 9561 and RUBINATE® 1245 from Huntsman Chemical Company in The Woodlands, Tex.

The aforementioned isocyanates are reacted with a polyol to prepare the polyurethane foam material. The polyurethane foams are hydrophilic, such that the foam absorbs aqueous liquids, particularly body fluids. The hydrophilicity of the polyurethane foams is typically provided by use of an isocyanate-reactive component, such as a polyether polyol, having a high ethylene oxide content. Examples of suitable polyols include adducts [e.g., polyethylene oxide, polypropylene oxide, and poly(ethylene oxide-propylene oxide) copolymer] of dihydric or trihydric alcohols (e.g., ethylene glycol, propylene glycol, glycerol, hexanetriol, and triethanolamine) and alkylene oxides (e.g., ethylene oxide, propylene oxide, and butylene oxide). Polyols having a high ethylene oxide content can also be made by other techniques as known in the art. Suitable polyols typically have a molecular weight (Mw) of 100 to 5,000 Da and contain an average functionality of 2 to 3.

The polyurethane foam is typically derived from (or in other words is the reaction product of) at least one polyether polyol having ethylene oxide (e.g. repeat) units. The polyether polyol typically has an ethylene oxide content of at least 10, 15, 20 or 25 wt-% and typically no greater than 75 wt-%. Such polyether polyol has a higher functionality than the polyisocyanate. In some embodiments, the average functionality is about 3. The polyether polyol typically has a viscosity of no greater than 1000 cps at 25° C. and in some embodiments no greater than 900, 800, or 700 cps. The molecular weight of the polyether polyol is typically at least 500 or 1000 Da and in some embodiments no greater than 4000 or 3500, or 3000 Da. Such polyether polyol typically has a hydroxyl number of at least 125, 130, or 140. Commercially available polyols include the polyether polyols CDB-33142 and CARPOL® GP-5171 from Carpenter Company in Richmond, Va.

In some embodiments, one or more polyether polyols having a high ethylene oxide content and a molecular weight (Mw) of no greater than 5500, or 5000, or 4500, or 4000, or 3500, or 3000 Da, as just described, are the primary or sole polyether polyols of the polyurethane foam. For example, such polyether polyols constitute at least 50, 60, 70, 80, 90, 95 or 100 wt-% of the total polyol component. Thus, the polyurethane foam may comprise at least 25, 30, 35, 40, 45 or 50 wt-% of polymerized units derived from such polyether polyols.

In other embodiments, one or more polyether polyols having a high ethylene oxide content are utilized in combination with other polyols. In some embodiments, the other polyols constitute at least 1, 2, 3, 4, or 5 wt-% of the total polyol component. The concentration of such other polyols typically does not exceed 40, or 35, or 30, or 25, or 20, or 15, or 10 wt-% of the total polyol component, i.e. does not exceed 20 wt-%, or 17.5 wt-%, or 15 wt-%, or 12.5 wt-%, or 10 wt-%, or 7.5 wt-%, or 5 wt-% of the polyurethane reaction mixture. Commercially available polyols include CARPOL® GP-700 from Carpenter Company in Richmond, Va. and ARCOL® E-434 from Bayer Material Science, Pittsburgh, Pa. In some embodiments, such optional other polyols may comprise polypropylene (e.g. repeat) units.

The polyurethane foam generally has an ethylene oxide content of at least 10, 11, or 12 wt-% and no greater than 20, 19, or 18 wt-%.

The kinds and amounts of polyisocyanate and polyol components are selected such that the polyurethane foam is relatively soft, yet resilient. In the production of polyurethane foams, the polyisocyanate component and polyol component are reacted such that an equivalence ratio of isocyanate groups to the sum of hydroxyl groups is no greater than 1 to 1. In some embodiments, the components are reacted such that there are excess hydroxyl groups (e.g. excess polyol). In such embodiments, the equivalence ratio of isocyanate groups to the sum of the hydroxy groups is at least 0.7 to 1.

The polyurethane is foamed by mixing the reactants in liquid form with a suitable amount of water or chemical blowing agent, suitable catalyst and other optional components, and allowing the mixture to foam and cure. It is preferred to use water for producing the polyurethane foams, because the water reacts with the isocyanate groups to liberate carbon dioxide. The amount of water is preferably in the range from 0.5 to 5 wt-% of the polyurethane reaction mixture. In some embodiments, the amount of water is no greater than 4 or 3 or 2 or 1 wt-% of the polyurethane reaction mixture.

The polyurethane typically comprises a surfactant to stabilize the foam. Various surfactants have been described in the art. In one embodiment, a silicone surfactant is employed that comprises ethylene oxide (e.g. repeat) units, optionally in combination with propylene oxide (e.g. repeat) units such DABCO® DC-198 from Air Products in Allentown, Pa. In some embodiments, the concentration of hydrophilic surfactant typically ranges from about 0.05 to 1 or 2 wt-% of the polyurethane reaction mixture.

The polyurethane foam may optionally comprise known and customary polyurethane formation catalysts such as organic tin compounds and/or an amine-type catalyst. The catalysts are preferably used in an amount of from 0.01 to 5 wt-% of the polyurethane reaction mixture. The amine-type catalyst is typically a tertiary amine. Examples of suitable tertiary amines include monoamines such as triethylamine, and dimethyl cyclohexylamine; diamines such as tetramethylethylenediamine, and tetramethylhexanediamine; triamines such as tetramethylguanidine; cyclic amines such as triethylenediamine, dimethylpiperadine, and methylmorphorine; alcoholamines such as dimethylaminoethanol, trimethylaminoethylethanolamine, and hydroxyethylmorphorine; ether amines such as bisdimethylaminoethyl ethanol; diazabicycloalkenes such as 1,5-diazabicyclo(5,4,0)undecene-7 (DBU), and 1,5-diazabicyclo(4,3,0)nonene-5; and organic acid salts of the diazabicycloalkenes such as phenol salt, 2-ethylhexanoate and formate of DBU. These amines can be used either singly or in combination. The amine-type catalyst can be used in an amount no greater than 4, 3, 2, 1 or 0.5 wt-% of the polyurethane. Commercially available catalysts include DABCO® BL-17 and DABCO® 33-LV from Air Products Company in Allentown, Pa.

The polyurethane foam may optionally comprise a superabsorbent polymer (SAP), also referred to as “hydrogels” and “hydrocolloids”. The SAP is substantially water-insoluble but consists of water-swellable polymers capable of absorbing large quantities of liquids (e.g. 10-100 times their weight). Various SAP materials have been described in the art (see, e.g., U.S. Pat. No. 4,410,571; U.S. Pat. No. 6,271,277; and U.S. Pat. No. 6,570,057). Suitable SAP materials include superabsorbents with low gel strength, high gel strength, surface cross-linked superabsorbents, uniformly cross-linked superabsorbents, or superabsorbents with varied cross-link density throughout the structure. Superabsorbents may be based on chemistries that include poly(acrylic acid), poly(iso-butylene-co-maleic anhydride), poly(ethylene oxide), carboxy-methyl cellulose, poly(-vinyl pyrrolidone), and poly(-vinyl alcohol). The superabsorbents may range in swelling rate from slow to fast. The superabsorbents may be in various degrees of neutralization. Counter-ions are typically Li⁺, Na⁺, and K⁺. Commercially available SAP includes LiquiBlock™ HS Fines from Emerging Technologies Inc. in Greensboro, N.C.

Favored SAP materials can be slightly network crosslinked polymers of partially neutralized polyacrylic acids or starch derivatives thereof. For example, the SAP may comprise from about 50 to about 95%, preferably about 75%, neutralized, slightly network crosslinked, polyacrylic acid (i.e. poly (sodium acrylate/acrylic acid)). As described in the art, network crosslinking serves to render the polymer substantially water-insoluble and, in part, determines the absorptive capacity and extractable polymer content characteristics of the precursor particles and the resultant macrostructures.

For embodiments wherein the polyurethane foam comprises SAP, the SAP is generally present within the foam as discrete pieces. Such pieces may have various shapes such as spherical, rounded, angular, or irregular pieces as well as fibers. The particles generally comprise a distribution of sizes ranging from about 1 micron to 500 microns in diameter or cross-section (largest dimension when not spherical). The particles are preferably a finely divided powder of a maximum particle size of less than 400, 300, or 200 microns.

When present, the concentration of SAP in the polyurethane foam is typically at least 1, 2, 3, 4, or 5 wt-% of the polyurethane reaction mixture and typically no greater than 30, 25, or 20 wt-% of the polyurethane reaction mixture. The minimal amount of SAP that can provide the desired properties (e.g. absorption capability, strike-through, rewet) is utilized. In some embodiments, the concentration of SAP is no greater than 17.5, or 15, or 12.5 or 10 wt-% of the polyurethane reaction mixture. In some embodiments, the inclusion of the SAP in the foam has little or no affect on the absorption capacity of the foam, yet surprisingly improves the strike-through and rewet of the foam and especially the absorbent foam composite.

The polyurethane foams may also optionally comprise pigments. It is common practice in the personal hygiene industry to print graphics, color and/or color indicators onto one or more layers of a hygiene article. Printing can be complicated and expensive. By coloring the absorbent foam layer, personal hygiene manufactures can incorporate color into their products without the need for specialized printing equipment and inks. In preferred embodiments, the pigment comes in a polyol carrier and is added to the poly liquid stream during manufacture of the polyurethane foam. Commercially available pigments include DispersiTech™ 2226 White, DispersiTech™ 2401 Violet, DispersiTech™ 2425 Blue, DispersiTech™ 2660 Yellow, and DispersiTech™ 28000 Red from Milliken in Spartansburg, S.C. and Pdi® 34-68020 Orange from Ferro in Cleveland, Ohio.

The polyurethane foam may optionally comprise other additives such as surface active substances, foam stabilizers, cell regulators, blocking agents to delay catalytic reactions, fire retardants, chain extenders, cross-linking agents, external and internal mold release agents, fillers, colorants, optical brighteners, antioxidants, stabilizers, hydrolysis inhibitors, as well as anti-fungal and anti-bacteria substances. Such other additives are typically collectively utilized at concentrations ranging from 0.05 to 10 wt-% of the polyurethane reaction mixture. Commercially available additives include DABCO®BA-100 (polymeric acid blocking agent) from Air Products Company in Allentown, Pa. and Triethanolamine LFG (cross-linking agent) from Dow Chemical Company in Midland, Mich.

The polyurethane foam typically has an average basis weight of at least 100, 150, 200, or 250 gsm and typically no greater than 500 gsm. In some embodiments the average basis weight is no greater than 450, or 400 gsm. The average density of the polyurethane foam is typically at least 3, 3.5 or 4 lbs/ft³ and no greater than 7 lbs/ft³.

The above description provides one technique for making suitable polyurethane foams. One can contemplate other techniques as well. For example, another technique for making suitable polyurethane foams is known as the “prepolymer” technique. In this technique, a prepolymer of polyol and isocyanate are reacted in an inert atmosphere to form a liquid polymer terminated with isocyanate groups. To produce the foamed polyurethane, the isocyanate-terminated prepolymer is thoroughly mixed with water and, optionally, a polyol in the presence of a catalyst or a cross-linker. Other suitable polyurethane foams can be made by high internal phase emulsion polymerization (HIPE).

As noted above, one of the advantages of the present invention is the ability to use a variety of foams so as to tailor the absorbent foam composite to a particular application. The above description of polyurethane foams is exemplary and in no way intended to limit the composition of the foam layer.

### Absorbent Layer

The absorbent layer may comprise a variety of liquid-absorbent materials. Exemplary absorbent materials include natural and synthetic fibers, absorbent foams, absorbent sponges, superabsorbent polymers, absorbent gelling materials, or any equivalent material or combinations of materials, or mixtures of these.

The fibers of the absorbent layer are hydrophilic, or a combination of both hydrophilic and hydrophobic fibers. Suitable fibers include those that are naturally occurring fibers (modified or unmodified), as well as synthetically made fibers. Examples of suitable unmodified/modified naturally occurring fibers include cotton, Esparto grass, bagasse, hemp, flax, silk, wool, wood pulp, chemically modified wood pulp, jute, rayon, ethyl cellulose, and cellulose acetate.

Suitable wood pulp fibers can be obtained from known chemical processes such as, but not limited to the Kraft and sulfite processes. A further suitable type of fibers is chemically stiffened cellulose, i.e., stiffened by chemical means to increase the stiffness of the fibers under both dry and aqueous conditions. Such means can include the addition of a chemical stiffening agent that, for example, coats and/or impregnates the fibers or by stiffening of the fibers by altering the chemical structure, e.g., by crosslinking polymer chains, as known in the art. Curl may be imparted to the fibers by methods including chemical treatment or mechanical twisting. Curl is typically imparted before crosslinking or stiffening.

Hydrophilic fibers, particularly (optionally modified) cellulosic fibers are typically preferred. However, hydrophilic fibers can also be obtained by hydrophilizing hydrophobic fibers, such as surfactant-treated or silica-treated thermoplastic fibers. Surfactant-treated fibers can be made by spraying the fiber with a surfactant, by dipping the fiber into a surfactant or by including the surfactant as part of the polymer melt in producing the thermoplastic fiber. Upon melting and resolidification, the surfactant will tend to remain at the surfaces of the thermoplastic fiber.

Suitable synthetic fibers can be made from polyvinyl chloride, polyvinyl fluoride, polytetrafluoroethylene, polyvinylidene chloride, polyacrylics, polyvinyl acetate, polyethylvinyl acetate, non-soluble or soluble polyvinyl alcohol, polyolefins such as polyethylene and polypropylene, polyamides such as nylon, polyesters, polyurethanes, polystyrenes, and the like. In some embodiments, the synthetic fibers are thermoplastic, e.g. having a melt point of at least 50° C.-75° C. and no greater than 190 or 175° C.

Generally the (e.g. thermoplastic) synthetic fibers have an average width, diameter, or cross-section dimension of at least 5, 10, 15, or 20 microns. The average diameter may range up to 1000 microns (1 mm), yet is typically no greater than 800 microns, or 700 microns, or 600 microns, and in some embodiments no greater than 500 microns or 400 microns. In some embodiments, the average diameter of the fibers of the web is no greater than 300, 250, 200, 150, 100, 75 or 50 microns. Smaller diameter staple fiber webs can provide improved flexibility (e.g. a lower work of compression). The filament cross sectional dimension (and shape of the cross section) is preferably substantially, or essentially, uniform along the length of the filament, e.g., uniformly round. The surface of the filament is typically smooth. The fibers can be in the shape or form of fibers, strips, or other narrow and long shapes. Aggregations can be made up of a plurality of fibers with the same or different plastic compositions, geometric shapes, sizes, and/or diameters. The fibers are typically solid. The fibers can be circular or round in cross section or non-circular in cross section, e.g., lobal, elliptical, rectangular, triangular, and shapes with radial arms such as “x-shaped”. For embodiments wherein a thermoplastic fiber is formed from melt-extrusion processes (e.g. spunbond or melt blown) the length of the fibers is continuous. The length of the staple fibers (i.e. fibers) is typically at least 1, 2, or 3 cm, and commonly no greater than 15 cm. In some embodiments, the length of the fibers is no greater than 10, 9, 8, or 7 cm.

The absorbent layer may be a preformed fibrous web. There are a variety of “dry-laid” and “wet-laid” web-making processes described in the art. Various absorbent layers and methods of making such have been described in the art. See, for example, U.S. Pat. No. 4,610,678 and U.S. Pat. No. 6,896,669.

The configuration and construction of the absorbent layer may be varied (e.g., the absorbent layer may have varying caliper zones (e.g., profiled so as to be thicker in the center), hydrophilic gradients, superabsorbent gradients, or lower density and lower average basis weight acquisition zones). The total absorbent capacity of the absorbent layer should, however, be compatible with the design loading and the intended use of the absorbent foam composite. In preferred embodiments, the absorption capacity of the absorbent layer is greater than that of the absorbent foam layer. In some embodiments, the absorption capacity of the second absorbent layer is 1.5×, 2×, 2.5× or even 3× that of the foam layer.

In some embodiments, the absorbent layer comprises superabsorbent polymer sandwiched between two layers of cellulosic fiber tissue. Commercially available products having a similar construction include Gelok 5240-72 from Gelok International in Dunbridge, Ohio.

In other embodiments, the absorbent layer comprises a preformed fibrous web with superabsorbent polymer dispersed within. In particular embodiments, the fibers are a cellulosic fibers.

In yet other embodiments, the absorbent layer comprises a layer of superabsorbent polymer and a tissue layer (e.g., cellulosic fiber). The superabsorbent polymer layer will face the foam layer (or heat set film) in the final construction of the absorbent foam composite.

In yet another embodiment, the absorbent layer has a basis weight from about 100 g/m² to about 700 g/m² which has been air-laid as a bottom layer of wood pulp fibers, a middle layer of wood pulp fibers and superabsorbent polymer disposed in amongst the fibers, and a top layer containing at least some wood pulp fibers.

### Heat-Settable Film

A heat-settable film may be used to maintain the slits in the foam layer, and in some embodiments also the absorbent layer, in an open configuration. The heat-settable film may be a thermoplastic material that has sufficient strength upon annealing to prevent the foam layer from completely retracting to close the slits.

Suitable heat-settable films are typically thermoplastic. Exemplary thermoplastic materials include polyester, polypropylene, polyethylene, and co-polymers of polypropylene and polyethylene.

Annealing involves heating the heat-settable film above the glass transition temperature (T_{g}) but below the melting point (Tₘ). Preferably, the heat-settable film is heated to, or near, its crystallization temperature (T_{c}). Heating can be provided, for example, by using heated rollers, IR irradiation, hot air treatment and/or heat chambers or ovens.

### Absorbent Foam Composite

A variety of permutations are possible for the construction of the absorbent foam composite based upon the choice of materials for the foam layer, absorbent layer, and optional heat-settable film. For example, in some embodiments, the absorbent foam composite comprises a hydrophilic polyurethane foam layer, a polyester film, and an absorbent layer comprising superabsorbent polymer sandwiched between two layers of cellulosic fiber tissue. In yet other embodiments, the hydrophilic polyurethane foam layer contains superabsorbent polymer. In yet still other embodiments, the absorbent foam composite comprises a hydrophobic polyurethane foam layer and an absorbent layer comprising superabsorbent polymer sandwiched between two layers of cellulosic fiber tissue.

Irrespective of the construction, the absorbent foam composite can be processed into various shapes including symmetrical (having a point, line, or plane of symmetry) or unsymmetrical shapes. Shapes that are envisioned include but are not limited to circles, ovals, squares, rectangles, pentagons, hexagons, octagons, trapezoids, truncated pyramids, hourglasses, dumbbells, dog bones, etc. The edges and corners can be straight or rounded. In some embodiments, the absorbent foam composite has an hour-glass or trapezoid shape. Although all layers of the absorbent foam composite can be the same size and shape, it is not necessary. In some embodiments, for example, the foam layer can be smaller than the absorbent layer. In other embodiments, the foam layer can be larger than the absorbent layer.

It is also contemplated that the foam layer can be further processed to contain cut-out regions that create voids, cavities, depressions, channels, or grooves. In addition, features may be added to the surface of the foam layer by a variety of embossing techniques.

The absorbent foam composite of the present invention typically has an absorption capacity (by weight) of at least 7, 10, 13, 16 or 20 g/g. In some embodiments, the absorption capacity ranges from about 7 g/g to about 17 g/g.

The absorbent foam composite can exhibit a strike through of less than 50, 30, 20, 10 or 5 seconds. In some embodiments, the strike through is no greater than 5, 2, or 1 seconds. The composite can exhibit a rewet that is less than 10, 7, 5, 3 or 1 grams. In some embodiments, the rewet is less than 0.6, 0.3, 0.2, 0.1 or 0.07 grams.

The absorbent foam composite can exhibit various combinations of the absorption capacity, strike through, and rewet properties. As noted above, an advantage of the present invention is the ability to tailor the properties of the absorbent foam composite to the desired end use application.

### Applications

The absorbent foam composites can be used in a variety of applications, including disposable absorbent articles such as personal hygiene articles (e.g., infant diapers, feminine hygiene pads and adult incontinence devices), medical bandages, pet pads and agricultural pads.

FIG. 7 depicts a cross-sectional view of an exemplary absorbent article comprising an absorbent foam composite made by the method of the present invention. The absorbent article comprises a liquid permeable topsheet 740, a liquid impermeable backsheet 742 and an absorbent foam composite 710 therebetween.

The liquid permeable topsheet 740 can consist of a nonwoven layer, porous foams, apertured plastic films, etc. Materials suitable for a topsheet should be soft and non-irritating to the skin and be readily penetrated by fluids. In some embodiments, the top sheet is made from a hydrophobic material. Exemplary hydrophobic materials include spun bond nonwovens comprising ethylene polymers, polypropylene polymers, and/or copolymers thereof.

The liquid impermeable backsheet 742 may consist of a thin plastic film, e.g., a polyethylene or polypropylene film, a nonwoven material coated with a liquid impervious material, a hydrophobic nonwoven material which resists liquid penetration, or laminates of plastic films and nonwoven materials. The backsheet material may be breathable so as to allow vapour to escape from the absorbent foam composite 710, while still preventing liquids from passing through the backsheet material.

The foam composite 710 comprises a foam layer 712, an absorbent layer 714, and a heat set film 724 in-between the foam layer 712 and absorbent layer 714, where both the foam layer 712 and heat set film 724 have at least partially congruent apertures through with fluids pass to the absorbent layer 714.

The topsheet 740 and the backsheet 742 typically extend beyond the absorbent foam composite 710 and are connected to each other, e.g., by gluing or welding by heat or ultrasonic, about the periphery of the absorbent foam composite 710. The topsheet 740 and/or the backsheet 742 may further, or alternatively, be attached to the absorbent foam core by any method known in the art, such as adhesive, heatbonding etc.

### Some Embodiments of the Disclosure

In a first embodiment, the present disclosure provides an absorbent foam composite comprising a foam layer having open slits that define apertures on at least a portion of the foam layer, and an absorbent layer.

In a second embodiment, the present disclosure provides the composite of the first embodiment, wherein the absorbent layer comprises apertures.

In a third embodiment, the present disclosure provides the composite of the first or second embodiment, further comprising a heat set film sandwiched between the foam layer and the absorbent layer, the heat set film joined to the foam layer and having open slits that define apertures that are at least partially congruent with the apertures of the foam layer.

In a fourth embodiment, the present disclosure provides the composite of the third embodiment, wherein the heat set film comprises at least one of polyester, polyamide, polyacrylonitrile, polypropylene and polyethylene.

In a fifth embodiment, the present disclosure provides the composite of the third or fourth embodiment, wherein the absorbent layer is adhesively laminated to the heat set film.

In a sixth embodiment, the present disclosure provides the composite of any one of the first to fifth embodiments, wherein the apertures are geometric shapes comprising at least one of diamonds, squares, and rectangles.

In a seventh embodiment, the present disclosure provides the composite of any one of the first to sixth embodiments, wherein the apertures are geometric shapes comprising diamonds.

In an eighth embodiment, the present disclosure provides the composite of any one of the first to fifth embodiments, wherein the apertures are curvilinear shapes comprising at least one of crescent-shaped apertures or s-shaped apertures.

In a ninth embodiment, the present disclosure provides the composite of any one of the first to eighth embodiments, wherein apertures extend across the entire foam layer.

In a tenth embodiment, the present disclosure provides the composite of any one of the first to ninth embodiments, wherein the apertures in the foam layer are larger in the middle of the foam layer than near its edges.

In an eleventh embodiment, the present disclosure provides the composite of any one of the first to tenth embodiments, wherein the foam layer is hydrophobic.

In a twelfth embodiment, the present disclosure provides the composite of any one of the first to tenth embodiments, wherein the foam layer is hydrophilic.

In a thirteenth embodiment, the present disclosure provides the composite of any one of the first to twelfth embodiments, wherein the foam layer comprises polyurethane.

In a fourteenth embodiment, the present disclosure provides the composite of the thirteenth embodiment, wherein the polyurethane foam comprises superabsorbent polymer.

In a fifteenth embodiment, the present disclosure provides the composite of any one of the first to fourteenth embodiments, wherein the foam layer is colored.

In a sixteenth embodiment, the present disclosure provides the composite of any one of the first to fifteenth embodiments, wherein the absorbent layer comprises at least one of natural fibers, synthetic fibers, absorbent foams, absorbent sponges, superabsorbent polymers, and absorbent gelling materials.

In a seventeenth embodiment, the present disclosure provides the composite of any one of the first to fifteenth embodiments, wherein the absorbent layer comprises superabsorbent polymer sandwiched between two layers of cellulosic fiber tissue.

In an eighteenth embodiment, the present disclosure provides the composite of any one of the first to fifteenth embodiments, wherein the absorbent layer comprises preformed fibrous web with superabsorbent polymer dispersed within.

In a nineteenth embodiment, the present disclosure provides a disposable absorbent article comprising the composite of any one of the first to eighteenth embodiments.

In a twentieth embodiment, the present disclosure provides a method of making an absorbent foam composite comprising slitting and spreading a foam layer to create open slits that define apertures, and combining an absorbent layer with the foam layer.

In a twenty-first embodiment, the present disclosure provides the method of the twentieth embodiment, further comprising joining the slit and spread foam layer to the absorbent layer.

In a twenty-second embodiment, the present disclosure provides the method the twentieth or twenty-first embodiment, wherein the absorbent layer comprises apertures.

In a twenty-third embodiment, the present disclosure provides the method of the twentieth embodiment, further comprising joining the absorbent layer and the foam layer, and slitting and spreading the absorbent layer simultaneously with slitting and spreading the foam layer to create open slits that define apertures in the absorbent layer that are at least partially congruent with the apertures in the foam layer.

In a twenty-fourth embodiment, the present disclosure provides the method of any one of the twentieth to twenty-third embodiments, further comprising annealing the foam layer after the spreading step to fix the slits in an open configuration.

In a twenty-fifth embodiment, the present disclosure provides the method of the twentieth embodiment, further comprising joining a heat-settable film to the foam layer such that the heat-settable film is sandwiched between the foam layer and the absorbent layer, slitting and spreading the heat-settable film simultaneously with the slitting and spreading of the foam layer to create open slits that define apertures in the heat-settable film that are at least partially congruent with the apertures in the foam layer, and annealing the heat-settable film to fix the slits in the foam layer and heat-settable layer in an open configuration.

In a twenty-sixth embodiment, the present disclosure provides the method of the twenty-fifth embodiment, wherein the heat-settable film is joined to the absorbent layer.

In a twenty-seventh embodiment, the present disclosure provides the method of the twenty-sixth embodiment, further comprising slitting and spreading the absorbent foam layer simultaneously with slitting and spreading the foam layer and heat-settable film to create open slits that define apertures in the absorbent layer that are at least partially congruent with the apertures in the foam layer.

In a twenty-eighth embodiment, the present disclosure provides the method of any one of the twentieth to twenty-seventh embodiments, wherein the apertures are geometric shapes comprising at least one of diamonds, squares, and rectangles.

In a twenty-ninth embodiment, the present disclosure provides the method of any one of the twentieth to twenty-seventh embodiments, wherein the apertures are geometric shapes comprising diamonds.

In a thirtieth embodiment, the present disclosure provides the method of any one of the twentieth to twenty-seventh embodiments, wherein the apertures are curvilinear shapes comprising at least one of crescent-shaped apertures or s-shaped apertures.

In a thirty-first embodiment, the present disclosure provides the method of any one of the twentieth to thirtieth embodiments, wherein apertures extend across the entire foam layer.

In a thirty-second embodiment, the present disclosure provides the method of any one of the twentieth to thirty-first embodiments, wherein the apertures in the foam layer are larger in the middle of the foam layer than near its edges.

In a thirty-third embodiment, the present disclosure provides the method of any one of the twentieth to thirty-second embodiments, wherein the foam layer is hydrophobic.

In a thirty-fourth embodiment, the present disclosure provides the method of any one of the twentieth to thirty-second embodiments, wherein the foam layer is hydrophilic.

In a thirty-fifth embodiment, the present disclosure provides the method of any one of the twentieth to thirty-fourth embodiments, wherein the foam layer comprises polyurethane.

In a thirty-sixth embodiment, the present disclosure provides the method of the thirty-fifth embodiment, wherein the polyurethane foam comprises superabsorbent polymer.

In a thirty-seventh embodiment, the present disclosure provides the method of any one of the twentieth to thirty-sixth embodiments, wherein the foam layer is colored.

In a thirty-eighth embodiment, the present disclosure provides the method of any one of the twentieth to thirty-seventh embodiments, wherein the absorbent layer comprises at least one of natural fibers, synthetic fibers, absorbent foams, absorbent sponges, superabsorbent polymers, and absorbent gelling materials.

In a thirty-ninth embodiment, the present disclosure provides the method of any one of the twentieth to thirty-seventh embodiments, wherein the absorbent layer comprises superabsorbent polymer sandwiched between two layers of cellulosic fiber tissue.

In a fortieth embodiment, the present disclosure provides the method of any one of the twentieth to thirty-seventh embodiments, wherein the absorbent layer comprises preformed fibrous web with superabsorbent polymer dispersed within.

### EXAMPLES

The following examples are presented to illustrate some of the advantages of the above absorbent foam composites and are not intended in any way to otherwise limit the scope of the invention.

### Ingredients

SUPRASEC® 9561—a modified diphenylmethane diisocyanate (MDI) obtained from Huntsman

Chemical Company in The Woodlands, Tex. USA. SUPRASEC® 9561 is reported to have an equivalent weight of 143 g/equivalent, a functionality of 2.10, an isocyanate content of 29.3%, a specific gravity at 25° C. of 1.21, and a viscosity at 25° C. of 36 cps.

RUBINATE® 1245—a polymeric diphenylmethane diisocyanate (polymeric MDI) obtained from Huntsman Chemical Company, The Woodlands, Tex., USA. RUBINATE® 1245 is reported to have an average Mw of 283 Da, an equivalent weight of 128 g/equivalent, a functionality of 2.21, a % isocyanate content of 32.8, a specific gravity at 25° C. of 1.23, and a viscosity at 25° C. of 25 cps.
CDB-33142—a polyether polyol product obtained from the Carpenter Company in Richmond, Va. USA. CDB-33142 is a blend prepared from glycerine, propylene oxide and ethylene oxide and is reported to have an average Mw of 2300 Da, an average Mn of 1200 Da, an hydroxyl number of 142, a functionality of 3; an ethylene oxide content of 26%; and a viscosity at 25° C. of 500 cps.
ARCOL® E-434—a polyether polyol product obtained from Bayer Material Science in Pittsburgh, Pa. USA. ARCOL® E-434 is prepared as a polyoxy-propylene triol modified with ethylene oxide and is reported to have an average Mw of 4800 Da, a hydroxyl number of 33.8-37.2, and a viscosity at 25° C. of 820 cps.
ARCOL® 34-28—a polyether polyol product obtained from Bayer Material Science in Pittsburgh, Pa. USA. ARCOL® 34-28 is prepared as a polyoxy-propylene triol modified with ethylene oxide and is reported to have a functionality of 3, an average Mw of 4800 Da, a hydroxyl number of 27 mg KOH/gram, and a viscosity at 25° C. of 2,240 cps.
CARPOL® GP-700—a polyether polyol product obtained from the Carpenter Company in Richmond, Va. USA. CARPOL® GP-700 is a blend prepared from glycerine, propylene oxide, and ethylene oxide and is reported to have an average Mw of 730-770 Da, an average Mn of 700 Da, a hydroxyl number of 240, a functionality of 3, an ethylene oxide content of 0%, and a viscosity at 25° C. of 250 cps.
CARPOL® GP-5171—a polyether polyol product obtained from the Carpenter Company in Richmond, Va. USA.
LiquiBlock™ HS Fines—a superabsorbent polymer (SAP) obtained from Emerging Technologies Inc. in Greensboro, N.C. USA. The SAP is a sodium salt of crosslinked polyacrylic acid and is reported to have a particle size distribution of 1-140 microns, a pH of 6, a NaCl absorption of 50 g/g, a deionized water absorption of >180 g/g, a moisture content of 2% maximum, and an apparent bulk density of 250 g/L.
Triethanolamine LFG (low freeze grade)—obtained from the Dow Chemical Company, Midland, Mich. USA.
DABCO® 33-LV—a solution of triethylene diamine (33 weight percent) in dipropylene glycol obtained from Air Products Company in Allentown, Pa. USA.
DABCO® BL-17—a tertiary amine catalyst obtained from Air Products Company in Allentown, Pa. USA.
DABCO® DC-198—silicone glycol copolymer surfactant obtained from Air Products Company in Allentown, Pa. USA.
DABCO® BA-100—a polymeric acid blocking agent obtained from Air Products Company in Allentown, Pa. USA.
Gelok 5240-72—an absorbent component obtained from Gelok International in Dunbridge, Ohio USA. The absorbent component is a layer of superabsorbent polymer (about 53% by weight of component) sandwiched between two layers of cellulosic fiber tissue (collectively about 47% by weight of component). Each tissue layer has a basis weight of 12 lbs per 300 ft², where the ream size standard is 500.
Gelok 5240-48—Gelok 5240-72 film laminate obtained from Gelok International in Dunbridge, Ohio USA. One side of the Gelok 5240-72 is adhesively laminated to a 1.0 mil polyester film which contains a heat activatable powder adhesive to facilitate lamination.
Gelok 5240-102—Gelok 5240-72 film laminate obtained from Gelok International in Dunbridge, Ohio USA. One side of the Gelok 5240-72 is polycoated with 3.5 mil polypropylene.
19PP/12PTC1/19PP PERF—polypropylene coated paper available from Prolamina in Neenah, Wis., USA.
MUL/BC 58—polyproylene coated paper obtained from Schoeller Company in Polaski, N.Y., USA.
DispersiTech™ 2226 White—obtained from Milliken in Spartansburg, S.C., USA.
DispersiTech™ 2401 Violet—obtained from Milliken in Spartansburg, S.C., USA.
DispersiTech™ 2425 Blue—obtained from Milliken in Spartansburg, S.C., USA.
DispersiTech™ 2660 Yellow—obtained from Milliken in Spartansburg, S.C., USA.
DispersiTech™ 2800 Red—obtained from Milliken in Spartansburg, S.C., USA.
Pdi® 34-68020 Orange—obtained from Ferro in Cleveland, Ohio, USA.

### Test Methods

Composite Thickness. Thickness was measured using a Digimatic Caliper, Model CD-6″ CS, available from Mitutoyo Corporation in Japan. Sample measurements were made in triplicate with the mean value reported.
Basis Weight. A rule die measuring 5.08 cm×5.08 cm (2 inches×2 inches) was used to cut the foam sample for basis weight measurement. The sample was weighed and the basis weight subsequently calculated. Sample measurements were made in triplicate with the mean value reported.
Absorption Capacity. Saline solution (90 ml of 0.9% NaCl in deionized water at room temperature or 21° C.) was poured into a 100 ml disposable Petri dish. A 5.08 cm×5.08 cm (2 inch×2 inch) sample was weighed and recorded as “dry weight”. The sample was immersed into the Petri dish and allowed to saturate for 5 minutes. The sample was removed by using tweezers to grab a corner of the sample. The sample was suspended vertically for 2 minutes. The wet weight was recorded. The absorption capacity and absorbed fluid were determined as follows:

Absorption Capacity g/g=[(wet sample wt.−dry sample wt.)/dry sample wt.]

Absorption Capacity g/cc=[(wet sample wt.−dry sample wt.)/dry sample volume]

Absorbed Fluid g=wet sample wt.−dry sample wt.

All sample measurements were made in triplicate with the mean value reported.
Strike Through. The strike through time was measured using saline solution and a test jig. The jig was made of plexiglass with the dimensions of 10.16 cm×10.16 cm×2.54 cm (4 inches×4 inches×1 inch). A 2.54 cm hole (1 inch) was cut in the center of the plexiglass jig. The test jig weighed 284 grams. The test sample had a dimension of at least 10.16 cm×10.16 cm. The test sample was placed under the test jig and positioned so that the hole in the plexiglass was directly above the center of the sample. Saline solution (10 mls of 0.9% NaCl in deionized water) was poured into the hole and the time (in seconds) required for the saline solution to penetrate into the test sample was recorded. To enhance visualization, the saline solution was colored with red food dye. The test sample was oriented so that the foam layer was in direct contact with the plexiglass surface of the test jig. In this orientation, the foam layer was the first surface of the test sample to come in contact with the saline solution. Sample measurements were made in triplicate with the mean value reported.
Rewet. The rewet was determined using the test jig described above for strike through time measurement. The test sample was at least 10.16 cm×10.16 cm. The test sample was placed under the test jig and positioned so that the hole in the plexiglass was directly above the center of the sample. The test samples were oriented so that the foam layer was in direct contact with the plexiglass surface of the test jig. In this orientation, the foam layer was the first surface of the test sample to come in contact with the saline solution. Saline (10 ml of 0.9% NaCl in deionized water) was poured into the hole and the sample was maintained in the test jig for 5 minutes. The load was 0.28 kPa (0.04 psi). The test jig was removed and a stack of ten sheets of WHATMAN #4 90 mm filter paper was placed on top of the test sample. Prior to placement on the sample, the stack of filter paper was weighed to obtain an initial weight. The test jig, weighing 284 grams, was reapplied to the sample and a 2000 gram weight was placed and centered on top of the plexiglass test jig, providing a loading of 3.52 kPa (0.51 psi) for 15 seconds. The assembly was removed and the stack of filter paper weighed again to obtain a final weight. The rewet measurement was calculated using the following equation:

Rewet (g)=final filter paper weight−initial filter paper weight.

All samples were made in triplicate and reported as the mean value.

### Example 1

An open cell hydrophilic polyurethane foam was prepared by adding SUPRASEC® 9561 (62.2 parts, 29.88 wt. %) to a mixture of CDB-33142 (100 parts, 48.04 wt. %), LiquiBlock™ HS Fines (30 parts, 14.41 wt. %), CARPOL® GP-5171 (5.4 parts, 2.59 wt. %), water (1.2 parts, 0.58 wt. %), triethanolamine LFG (3.7 parts, 1.78 wt. %), DABCO® DC-198 (1.0 parts, 0.48 wt. %), ARCOL® E-434 (4.0 parts, 1.92 wt. %), DABCO® 33-LV (0.45 parts, 0.22 wt. %), DABCO® BL-17 (0.10 parts, 0.05 wt. %), DABCO® BA-100 (0.12 parts, 0.06 wt. %), and casting the combination of foam ingredients onto the polyester film side of the Gelok 5240-48. The polyester film side of a second layer of Gelok 5240-48 was applied to the opposite side of the foam as it passed between a pair of metering rolls, such that the foam was sandwiched between two layers of Gelok 5420-48. The foam was cured in an oven at 116° C. (240° F.) for 3.0 minutes.

The composite had an average thickness of 7.5 mm, an average basis weight of 890 gsm, and an average composite density of 0.1192 g/cc or 7.44 pcf. The Gelok 5240-48 had an average thickness of 0.27 mm, and an average basis weight of 109 gsm. The foam layer had an average thickness of 6.9 mm, an average basis weight of 671 gsm, and an average density of 0.0973 g/cc or 6.07 pcf.

The composite was then skived through the center of the foam layer to create two nearly equally constructed foam composites. Such skiving equipment is available from Baumer of America, Inc., Towaco, N.J. One of the two foam composites had an average thickness of 3.7 mm, an average basis weight of 459.8 gsm, and an average density of 0.1248 g/cc or 7.79 pcf.

After skiving, one of the two foam composites was skip slit through all three layers. Skip slitting was carried out with a stainless steel die measuring 10.16 mm×10.16 mm (4 inches×4 inches). The skip slit blade depth was 4.7 mm and the skip slit pattern was 9-2-2. The first digit represents the slit length in mm. The second digit represents the distance in mm between slits in the machine direction. The third digit represents the distance in mm between slits in the cross direction. The adjacent skip slit row is offset by ½ times the slit length. This sequence is repeated across the entire cross direction of the die.

For strike through and rewet testing, the skip slit foam composite was placed into the jig with opposing clamps connected by a screw. The foam composite was spread horizontally to a certain percentage of its original length. The apparatus was similar to a tensile tester. Strike through and rewet were measured at various spread percentages.

The skip slit foam composite (no spread) had an average strike through of 1.9 seconds, an average rewet of 0.13 grams, an average absorbed fluid of 16.75 grams, and an average absorption capacity of 13.76 g/g or 1.59 g/cc.

The absorbent foam composite created by spreading the skip slit foam composite 20% had an essentially instantaneous strike through of 0.1 seconds and an average rewet of 0.52 grams. The absorbent foam composite created by spreading the skip slit foam composite 40% had an essentially instantaneous strike through of 0.1 seconds and an average rewet of 0.50 grams.

### Example 2

An open cell hydrophilic polyurethane foam was prepared by adding SUPRASEC® 9561 (71.0 parts, 38.30 wt. %) to a mixture of CDB-33142 (100 parts, 53.95 wt. %), CARPOL® GP-5171 (6.0 parts, 3.24 wt. %), water (2.0 parts, 1.08 wt. %), triethanolamine LFG (3.7 parts, 2.00 wt. %), DABCO® DC-198 (1.0 parts, 0.54 wt. %), ARCOL® E-434 (1.0 parts, 0.54 wt. %), DABCO® 33-LV (0.45 parts, 0.24 wt. %), DABCO® BL-17 (0.10 parts, 0.05 wt. %), DABCO® BA-100 (0.12 parts, 0.06 wt. %), and casting the combination of foam ingredients onto the polyester film side of the Gelok 5240-48. A Schoeller MUL/BC 58 polypropylene coated release paper was applied to the opposite side of the foam as it was conveyed between a pair of metering rolls. The foam was cured in an oven at 132° C. (270° F.) for 2.18 minutes. After curing, the release paper was stripped from the foam composite.

The open cell foam had an average thickness of 2.48 mm (0.0977 inches), an average basis weight of 127.9 gsm, and an average density of 0.0525 g/cc or 3.27 pcf.

The foam composite had an average thickness of 2.79 mm (0.1097 inches), an average basis weight of 250.8 gsm, and an average density of 0.0914 g/cc or 5.70 pcf.

The foam composite was skip slit through all three layers. Skip slitting was carried out with a stainless steel die measuring 10.16 mm×10.16 mm (4 inches×4 inches). The skip slit blade depth was 4.7 mm and the skip slit pattern was 5-2-2.

For strike through and rewet testing, the skip slit foam composite was placed into the jig with opposing clamps connected by a screw. The foam composite was spread horizontally to a certain percentage of its original length. The apparatus was similar to a tensile tester. Strike through and rewet were measured at various spread percentages.

The skip slit foam composite (no spread) had an average strike through of 0.52 seconds, an average rewet of 0.46 grams, an average absorbed fluid of 9.69 grams, and an average absorption capacity of 14.63 g/g or 1.30 g/cc.

The absorbent foam composite created by spreading the skip slit foam composite 20% had an essentially instantaneous strike through of 0.1 seconds and an average rewet of 0.52 grams. The absorbent foam composite created by spreading the skip slit foam composite 40% had an essentially instantaneous strike through of 0.1 seconds and an average rewet of 0.62 grams.

### Example 3

An open cell hydrophilic polyurethane foam was prepared by adding SUPRASEC® 9561 (65.0 parts, 33.85 wt. %) to a mixture of CDB-33142 (100 parts, 52.08 wt. %), LIQUIBLOCK™ HS Fines (13.0 parts, 6.77 wt. %), CARPOL® GP-5171 (6.6 parts, 3.44 wt. %), water (2.2 parts, 1.15 wt. %), triethanolamine LFG (3.7 parts, 1.93 wt. %), DABCO® DC-198 (1.0 parts, 0.52 wt. %), DABCO® 33-LV (0.35 parts, 0.18 wt. %), DABCO® BL-17 (0.08 parts, 0.04 wt. %), DABCO® BA-100 (0.10 parts, 0.05 wt. %), and casting the combination of foam ingredients onto the polyester film side of Gelok 5240-48. A 19PP/12PTC1/19PP PERF polypropylene coated paper available from Prolamina in Neenah, Wis. USA, was applied to the opposite side of the foam as it was conveyed between a pair of metering rolls. The foam was cured in an oven at 99° C. (210° F.) for 2.25 minutes. After curing, the release paper was stripped from the foam composite.

The open cell foam had an average thickness of 2.53 mm (0.0995 inches), an average basis weight of 164.4 gsm, and an average density of 0.0650 g/cc or 4.06 pcf.

The foam composite had an average thickness of 2.83 mm (0.1115 inches), an average basis weight of 283.7 gsm, and an average density of 0.1002 g/cc or 6.25 pcf.

The foam composite was skip slit through all three layers. Skip slitting was carried out with a stainless steel anvil nip roll against a stainless steel patterned cutting die roll having a 5-2-2 skip slit pattern. The blade depth was 1.0 mm.

For strike through and rewet testing, the skip slit foam composite was placed into the jig with opposing clamps connected by a screw. The foam composite was spread horizontally to a certain percentage of its original length. The apparatus was similar to a tensile tester. Strike through and rewet were measured at various spread percentages.

The skip slit foam composite (no spread) had an average strike through of 3.2 seconds, an average rewet of 0.27 grams, an average absorbed fluid of 11.64 grams, and an average absorption capacity of 15.59 g/g or 1.59 g/cc.

The absorbent foam composite created by spreading the skip slit foam composite 20% had an averages strike through of 0.6 seconds and an average rewet of 0.29 grams. The absorbent foam composite created by spreading the skip slit foam composite 40% had an essentially instantaneous strike through of 0.1 seconds and an average rewet of 0.27 grams.

### Comparative Example 3

The open cell hydrophilic polyurethane foam of Example 3 was prepared by replacing the Gelok 5240-48 with a second 19PP/12PTC1/19PP PERF polypropylene coated paper available from Prolamina in Neenah, Wis., USA. The foam was cured in an oven at 99° C. (210° F.) for 2.25 minutes. After curing, the release papers were stripped from the foam.

The foam was skip slit with a stainless steel anvil nip roll against a stainless steel patterned cutting die roll having a 5-2-2 skip slit pattern and a blade depth of 1.0 mm.

The skip slit foam was placed into the jig with opposing clamps connected by a screw. This enabled the foam to be spread horizontally to open the slits.

Several foam samples were stretched 27% and placed into an oven at 150° C. for 5 minutes. The foam was allowed to cool for 3 minutes prior to removal from the spreading device. After cooling, the foam samples retained an average skip slit spread of 4.6%.

Several additional foam samples were stretched 45% and heated and cooled as above. After removal from the spreading device, the foam samples retained an average spread of 20.2%.

The skip slit foam (no spread) had an average strike through of 5.1 seconds, an average rewet of 6.82 grams, an average absorbed fluid of 5.76 grams, and an average absorption capacity of 11.30 g/g or 0.79 g/cc.

The skip slit foam spread 4.6% had an average strike through of 2.8 seconds, an average rewet of 7.58 grams, an average absorbed fluid of 4.73 grams, and an average absorption capacity of 10.94 g/g or 0.65 g/cc.

The skip slit foam spread 20.2% had an average strike through of 2.3 seconds, an average rewet of 7.74 grams, an average absorbed fluid of 4.54 grams, and an average absorption capacity of 10.22 g/g or 0.62 g/cc.

### Example 4

A skip slit foam composite made according to the procedure in Example 3 was placed into the jig with opposing clamps connected by a screw. The skip slit foam composite was stretched 23% in the apparatus and placed into an oven at 150° C. for 5 minutes. The foam composite was allowed to cool for 3 minutes prior to removal from the spreading device. After cooling, the foam composite retained a spread of 19.5%.

The absorbent foam composite created by spreading the skip slit foam composite 19.5% had an instantaneous strike through of 0.1 seconds, an average rewet of 0.11 grams, an average absorbed fluid of 10.88 grams, and an average absorption capacity of 16.41 g/g or 1.49 g/cc.

### Example 5

An open cell hydrophilic polyurethane foam prepared according to Example 3 was cast onto the polypropylene film side of Gelok 5240-102. A 19PP/12PTC1/19PP PERF polypropylene coated paper, available from Prolamina in Neenah, Wis. USA, was applied to the opposite side of the foam as it was conveyed between a pair of metering rolls. The foam was cured in an oven at 121° C. (250° F.) for 2.25 minutes. After curing, the release paper was stripped from the foam composite.

The open cell foam had an average thickness of 2.44 mm (0.0959 inches), an average basis weight of 182.9 gsm, and an average density of 0.0778 g/cc or 4.85 pcf.

The foam composite had an average thickness of 2.74 mm (0.1079 inches), an average basis weight of 305.6 gsm, and an average density of 0.1149 g/cc or 7.17 pcf.

The foam composite was skip slit through all three layers. Skip slitting was carried out with a stainless steel anvil nip roll against a stainless steel patterned cutting die roll having a 5-2-2 skip slit pattern. The blade depth was 1.0 mm.

For strike through and rewet testing, the skip slit foam composite was placed into a jig with opposing clamps connected by a screw. The foam composite was spread horizontally to a certain percentage of its original length. The apparatus was similar to a tensile tester. Strike through and rewet were measured at various spread percentages.

The skip slit foam composite (no spread) had an average strike through of 4.3 seconds, an average rewet of 0.18 grams, an average absorbed fluid of 10.92 grams, and an average absorption capacity of 14.57 g/g or 1.49 g/cc.

The absorbent foam composite created by spreading the skip slit foam composite 20% had an averages strike through of 1.3 seconds and an average rewet of 0.15 grams. The absorbent foam composite created by spreading the skip slit foam composite 40% had an average strike through of 0.9 seconds and an average rewet of 0.22 grams.

### Example 6

A skip slit foam composite made according to the procedure in Example 5 was placed into the jig with opposing clamps connected by a screw. The skip slit foam composite was stretched 28% in the apparatus and placed into an oven at 150° C. for 5 minutes. The foam composite was allowed to cool for 3 minutes prior to removal from the spreading device. After cooling, the foam composite retained a skip slit spread of 17.5%.

The absorbent foam composite created by spreading the skip slit foam composite 17.5% had an average strike through of 0.7 seconds, an average rewet of 0.17 grams, an average absorbed fluid of 8.93 grams, and an average absorption capacity of 12.52 g/g or 1.22 g/cc.

### Example 7

An open cell hydrophobic polyurethane foam was prepared by adding RUBINATE® 1245 (28.4 parts, 21.55 wt. %) to a mixture of Arcol E-434 (50 parts, 37.94 wt. %), Arcol 34-28 (50 parts, 37.94 wt. %), water (1.0 parts, 0.76 wt. %), triethanolamine LFG (1.0 parts, 0.76 wt. %), DABCO® DC-198 (0.12 parts, 0.09 wt. %), DABCO® 33-LV (1.00 parts, 0.76 wt. %), DABCO® BA-100 (0.25 parts, 0.19 wt. %), and casting the combination of foam ingredients onto a bottom release liner, 19PP/12PTC1/19PP PERF polypropylene coated paper available from Prolamina in Neenah, Wis. USA. The same release paper was applied to the opposite side of the foam ingredients as they were conveyed between a pair of metering rolls. The foam was hand drawn and placed into an oven at 88° C. (190° F.) for 5 minutes as in a batch process. After curing, the release papers were stripped from the foam. The foam was attached to Gelok 5240-72 using Spray 77 Adhesive, available from 3M Company, St. Paul, Minn. USA.

The composite was then skip slit through all layers. Skip slitting was carried out with a stainless steel anvil nip roll against a stainless steel patterned cutting die roll having a 5-2-2 skip slit pattern. The blade depth was 1.0 mm.

The open cell foam had an average thickness of 2.93 mm (0.1154 inches), an average basis weight of 293.7 gsm, and an average density of 0.1026 g/cc or 6.40 pcf.

The foam composite had an average thickness of 3.13 mm (0.1232 inches), an average basis weight of 401.7 gsm, and an average density of 0.1281 g/cc or 7.99 pcf.

For strike through and rewet testing, the skip slit foam composite was placed into the jig with opposing clamps connected by a screw. The foam composite was spread horizontally to a certain percentage of its original length. The apparatus was similar to a tensile tester. Strike through and rewet were measured at various spread percentages.

The skip slit foam composite (no spread) had an average strike through greater than 300 second (test was terminated after 5 minutes), an average rewet of 6.39 grams, an average absorbed fluid of 8.04 grams, and an average absorption capacity of 7.79 g/g or 1.10 g/cc.

The absorbent foam composite created by spreading the skip slit foam composite 20% had an average strike through of 47.4 seconds and an average rewet of 0.07 grams. The absorbent foam composite created by spreading the skip slit foam composite 40% had an average strike through of 25.9 seconds and an average rewet of 0.13 grams.

### Comparative Example 7

The open cell hydrophobic polyurethane foam was prepared as described in Example 7. The foam was skip slit with a stainless steel anvil nip roll against a stainless steel patterned cutting die roll having a 5-2-2 skip slit pattern. The blade depth was 1.0 mm.

The skip slit foam (no spread) had an average strike through greater than 300 second (test was terminated after 5 minutes), an average rewet of 6.16 grams, an average absorbed fluid of 0.16 grams, and an average absorption capacity of 0.21 g/g or 0.02 g/cc.

The skip slit foam with 20% spread had a strike through greater than 300 seconds (test was terminated after 5 minutes) and an average rewet of 5.03 grams. The slit foam with 40% spread had an average strike through greater than 300 seconds (test was terminated after five minutes) and an average rewet of 5.74 grams.

### Example 8

An open cell hydrophilic polyurethane foam was prepared by adding SUPRASEC® 9561 (65.0 parts, 33.85 wt. %) to a mixture of CDB-33142 (100 parts, 52.08 wt. %), LIQUIBLOCK™ HS Fines (13.0 parts, 6.77 wt. %), CARPOL® GP-5171 (6.6 parts, 3.44 wt. %), water (2.2 parts, 1.15 wt. %), triethanolamine LFG (3.7 parts, 1.93 wt. %), DABCO® DC-198 (1.0 parts, 0.52 wt. %), DABCO® 33-LV (0.35 parts, 0.18 wt. %), DABCO® BL-17 (0.08 parts, 0.04 wt. %), DABCO® BA-100 (0.10 parts, 0.05 wt. %), and casting the combination of foam ingredients onto the polyester film side of Gelok 5240-48. A 19PP/12PTC1/19PP PERF polypropylene coated paper available from Prolamina in Neenah, Wis. USA, was applied to the opposite side of the foam as it was conveyed between a pair of metering rolls. The foam was cured in an oven at 99° C. (210° F.) for 2.25 minutes. After curing, the release paper was stripped from the foam composite.

The open cell foam had an average thickness of 2.53 mm (0.0995 inches), an average basis weight of 164.4 gsm, and an average density of 0.0650 g/cc or 4.06 pcf.

The foam composite had an average thickness of 2.83 mm (0.1115 inches), an average basis weight of 283.7 gsm, and an average density of 0.1002 g/cc or 6.25 pcf.

The foam composite was skip slit through all three layers. Skip slitting was carried out with a stainless steel die measuring 10.16 mm×10.16 mm (4 inches×4 inches). The blade depth was 4.7 mm. Various slit patterns were used as provided in Table 1 below. The first digit represents the slit length in mm. The second digit represents the distance in mm between slits in the machine direction. The third digit represents the distance in mm between slits in the cross direction. The adjacent skip slit row is offset by ½ times the slit length. This sequence is repeated across the entire cross direction of the die.

For strike through and rewet testing, the skip slit foam composite was placed into the jig with opposing clamps connected by a screw. The absorbent foam composite was created by spreading the skip slit foam composite 20%. Values for strike through and rewet for the various patterns of apertures are reported in Table 1.

TABLE 1

| Slit Pattern | Strike Through (sec) | Rewet (g) |
|---|---|---|
| 13-3-2 | Instantaneous | 0.55 |
| 9-3-2 | Instantaneous | 0.29 |
| 9-2-2 | Instantaneous | 0.39 |
| 5-2-2 | Instantaneous | 0.35 |

### Example 9

Colored open cell hydrophilic polyurethane foams 9A-9F were prepared by adding SUPRASEC® 9561 (59.5 parts) to a mixture of CDB-33142 (100 parts), LiquiBlock™ HS Fines (30 parts), CARPOL® GP 700 (3.6 parts), water (1.2 parts), triethanolamine LFG (3.7 parts), DABCO® DC-198 (2.0 parts), ARCOL® E-434 (4.0 parts), DABCO® 33-LV (0.45 parts), DABCO® BA-100 (0.12 parts), DABCO® BL-17 (0.10 parts) and colorant as specified in Table 2 below, and curing at 100° C. for 10 minutes.

TABLE 2

| | Ex. 9A | Ex. 9B | Ex. 9C | Ex. 9D | Ex. 9E | Ex. 9F |
|---|---|---|---|---|---|---|
| | Yellow | Orange | Blue | Violet | Red | Lavender |
| Dispersi- | 2.0 parts | | | | | |
| Tech ™ | | | | | | |
| 2660 Yellow | | | | | | |
| Pdi ® | | 2.0 parts | | | | |
| 34-68020 | | | | | | |
| Orange | | | | | | |
| Dispersi- | | | 2.0 parts | | | |
| Tech ™ | | | | | | |
| 2425 Blue | | | | | | |
| Dispersi- | | | | 2.0 parts | | |
| Tech ™ | | | | | | |
| 2401 Violet | | | | | | |
| Dispersi- | | | | | 2.0 parts | |
| Tech ™ | | | | | | |
| 2800 Red | | | | | | |
| Dispersi- | | | | | | 0.4 parts |
| Tech ™ | | | | | | |
| 2401 Violet | | | | | | |
| Dispersi- | | | | | | 1.0 parts |
| Tech ™ | | | | | | |
| 2226 White | | | | | | |

The embodiments described above and illustrated in the figures are presented by way of example only and are not intended as a limitation upon the concepts and principles of the present invention.

Thus, the invention provides, among other things, an absorbent foam composite and method of making the absorbent foam composite. Various features and advantages of the invention are set forth in the following claims.

What is claimed is:

1. An absorbent foam composite comprising:
a foam layer having open slits that define apertures on at least a portion of the foam layer; and
an absorbent layer.

2. The absorbent foam composite of claim 1, wherein the absorbent layer comprises apertures.

3. The absorbent foam composite of claim 1, further comprising a heat set film sandwiched between the foam layer and the absorbent layer, the heat set film joined to the foam layer and having open slits that define apertures that are at least partially congruent with the apertures of the foam layer.

4. The absorbent foam composite of claim 3, wherein the heat set film comprises at least one of polyester, polyamide, polyacrylonitrile, polypropylene and polyethylene.

5. The absorbent foam composite of claim 3, wherein the absorbent layer is adhesively laminated to the heat set film.

6. The absorbent foam composite of claim 1, wherein the apertures are geometric shapes comprising at least one of diamonds, squares, and rectangles.

7. The absorbent foam composite of claim 1, wherein the apertures are geometric shapes comprising diamonds.

8. The absorbent foam composite of claim 1, wherein the apertures are curvilinear shapes comprising at least one of crescent-shaped apertures or s-shaped apertures.

9. The absorbent foam composite of claim 1, wherein apertures extend across the entire foam layer.

10. The absorbent foam composite of claim 1, wherein the apertures in the foam layer are larger in the middle of the foam layer than near its edges.

11. The absorbent foam composite of claim 1, wherein the foam layer is hydrophobic.

12. The absorbent foam composite of claim 1, wherein the foam layer is hydrophilic.

13. The absorbent foam composite of claim 1, wherein the foam layer comprises polyurethane.

14. The absorbent foam composite of claim 13, wherein the polyurethane foam comprises superabsorbent polymer.

15. The absorbent foam composite of claim 1, wherein the foam layer is colored.

16. The absorbent foam composite of claim 1, wherein the absorbent layer comprises at least one of natural fibers, synthetic fibers, absorbent foams, absorbent sponges, superabsorbent polymers, and absorbent gelling materials.

17. The absorbent foam composite of claim 1, wherein the absorbent layer comprises superabsorbent polymer sandwiched between two layers of cellulosic fiber tissue.

18. The absorbent foam composite of claim 1, wherein the absorbent layer comprises preformed fibrous web with superabsorbent polymer dispersed within.

19. A disposable absorbent article comprising the absorbent foam composite of claim 1.

20. A method of making an absorbent foam composite comprising:
slitting and spreading a foam layer to create open slits that define apertures; and
combining an absorbent layer with the foam layer.

21. The method of claim 20, further comprising joining the slit and spread foam layer to the absorbent layer.

22. The method of claim 20, wherein the absorbent layer comprises apertures.

23. The method of claim 20, further comprising joining the absorbent layer and the foam layer, and slitting and spreading the absorbent layer simultaneously with slitting and spreading the foam layer to create open slits that define apertures in the absorbent layer that are at least partially congruent with the apertures in the foam layer.

24. The method of claim 20, further comprising annealing the foam layer after the spreading step to fix the slits in an open configuration.

25. The method of claim 20, further comprising joining a heat-settable film to the foam layer such that the heat-settable film is sandwiched between the foam layer and the absorbent layer, slitting and spreading the heat-settable film simultaneously with the slitting and spreading of the foam layer to create open slits that define apertures in the heat-settable film that are at least partially congruent with the apertures in the foam layer, and annealing the heat-settable film to fix the slits in the foam layer and heat-settable layer in an open configuration.

26. The method of claim 25, wherein the heat-settable film is joined to the absorbent layer.

27. The method of claim 26, further comprising slitting and spreading the absorbent foam layer simultaneously with slitting and spreading the foam layer and heat-settable film to create open slits that define apertures in the absorbent layer that are at least partially congruent with the apertures in the foam layer.

28. The method of claim 20, wherein the apertures are geometric shapes comprising at least one of diamonds, squares, and rectangles.

29. The method of claim 20, wherein the apertures are geometric shapes comprising diamonds.

30. The method of claim 20, wherein the apertures are curvilinear shapes comprising at least one of crescent-shaped apertures or s-shaped apertures.

31. The method of claim 20, wherein apertures extend across the entire foam layer.

32. The method of claim 20, wherein the apertures in the foam layer are larger in the middle of the foam layer than near its edges.

33. The method of claim 20, wherein the foam layer is hydrophobic.

34. The method of claim 20, wherein the foam layer is hydrophilic.

35. The method of claim 20, wherein the foam layer comprises polyurethane.

36. The method of claim 35, wherein the polyurethane foam comprises superabsorbent polymer.

37. The method of claim 20, wherein the foam layer is colored.

38. The method of claim 20, wherein the absorbent layer comprises at least one of natural fibers, synthetic fibers, absorbent foams, absorbent sponges, superabsorbent polymers, and absorbent gelling materials.

39. The method of claim 20, wherein the absorbent layer comprises superabsorbent polymer sandwiched between two layers of cellulosic fiber tissue.

40. The method of claim 20, wherein the absorbent layer comprises preformed fibrous web with superabsorbent polymer dispersed within.
